(19) United States
(12) Patent Application Publication
(10) Pub. No.: US 2025/0016338 A1
(43) Pub. Date: Jan. 9, 2025

(54) VIDEO ENCODERS AND DECODERS FOR ARTIFICIAL INTELLIGENCE APPLICATIONS

(71) Applicants: Palanivel Guruva Reddiar, Gilbert, AZ (US); Suresh Vasu, Bengaluru (IN); Paul Michael Lucero, Chandler, AZ (US)

(72) Inventors: Palanivel Guruva Reddiar, Gilbert, AZ (US); Suresh Vasu, Bengaluru (IN); Paul Michael Lucero, Chandler, AZ (US)

(21) Appl. No.: 18/890,172

(22) Filed: Sep. 19, 2024

(51) Int. Cl. H04N 19/30; G06V 10/74; G06V 10/764; H04N 19/105; H04N 19/132; H04N 19/139; H04N 19/172; H04N 19/46; H04N 19/50

(52) U.S. Cl. CPC H04N 19/30; G06V 10/74; G06V 10/764; H04N 19/105; H04N 19/132; H04N 19/139; H04N 19/172; H04N 19/46; H04N 19/50

(57) ABSTRACT

Example systems, apparatus, articles of manufacture, and methods that implement video encoders and decoders for artificial intelligence applications are disclosed. Example apparatus disclosed herein are to assign a video frame to one of a plurality of layers of an encoding prediction structure based on at least one of a video metric or an artificial intelligence metric associated with the video frame. Disclosed example apparatus are also to provide prediction layer metadata for the video frame to a video encoder that is to encode the video frame in a video stream, the prediction layer metadata to identify the one of the plurality of layers.

### FIELD OF THE DISCLOSURE

This disclosure relates generally to video encoding and decoding and, more particularly, to video encoders and decoders for artificial intelligence applications.

### BACKGROUND

In distributed artificial intelligence (AI) applications, such as distributed video analytics, video decoding for AI processing and subsequent video encoding of the AI output can be performed at multiple compute nodes (e.g., compute devices) in the application pipeline. For example, a compute node in the AI pipeline may decode input video for processing by an AI algorithm to detect and classify objects in frames of the input video. The compute node may then encode output video frames of the AI algorithm, which are labeled with the detected and classified objects, to form an output video stream for transmission to a subsequent compute node in the pipeline.

### BRIEF DESCRIPTION OF THE DRAWINGS

FIG. 1 is a block diagram of an example distributed AI application pipeline including example video codecs for AI applications as disclosed herein.

FIG. 2 is a block diagram of an example implementation of one or more of the example video codecs of FIG. 1.

FIG. 3 is a block diagram of example encoder enhancement circuitry and video encoder circuitry of FIG. 2 in combination with an example AI application.

FIG. 4 illustrates an example implementation of the encoder enhancement circuitry of FIGS. 2 and/or 3.

FIG. 5 illustrates an example implementation of an AI application that can provide AI metrics to the encoder enhancement circuitry of FIGS. 2, 3 and/or 4.

FIG. 6 illustrates example video encoding prediction structures.

FIG. 7 is a block diagram of example implementation of decoder enhancement circuitry included in the example video codec of FIG. 2.

FIGS. 8 and 9 are flowcharts representative of example machine readable instructions and/or example operations that may be executed, instantiated, and/or performed by example programmable circuitry to implement the example encoder enhancement circuitry of FIGS. 2, 3 and/or 4.

FIG. 10 is a flowchart representative of example machine readable instructions and/or example operations that may be executed, instantiated, and/or performed by example programmable circuitry to implement the example decoder enhancement circuitry of FIG. 7.

FIG. 11 is a block diagram of an example processing platform including programmable circuitry structured to execute, instantiate, and/or perform the example machine readable instructions and/or perform the example operations of FIGS. 8-10 to implement the video codec of FIG. 2.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 8-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In distributed AI applications, such as distributed video analytics, a compute node in the AI pipeline may decode input video for processing by an AI algorithm and then encode output video frames of the AI algorithm to form an output video stream for transmission to a subsequent compute node in the pipeline. However, the compute node may expend resources to decode video frames for processing by the AI algorithm even if it is unlikely any objects will be detected or reliably classified in those frames. Furthermore, existing video encoders typically use a flat encoding prediction structure in which each preceding frame in a group of pictures (GOP) is a reference for a subsequent frame, thereby requiring decoding of all frames in the GOP. Video decoding for AI processing may also involve image scaling, image cropping, color space conversion, etc. Thus, video decoding performed by a compute node for AI processing may be computationally and/or memory intensive, thereby consuming substantial computational and/or memory resources of the compute node and potentially limiting the availability of such resources for AI processing itself.

Example enhanced video codecs disclosed herein focus video decoding on video frames that are likely to be useful for AI processing in a compute node, and skip decoding of video frames that are unlikely to be useful for AI processing. By skipping the decoding of video frames that are unlikely to be useful for AI processing, such example enhanced video codecs conserve computational and/or memory resources of the compute node, thereby allowing more resources to be available for AI processing. To enable the decoding of select video frames to be skipped, some example enhanced video codecs disclosed herein implement an efficient, dynamic encoding prediction structure, instead of the flat encoding prediction structure mentioned above. In an example dynamic encoding prediction structure, video frames determined to be useful for AI processing, such as frames exhibiting significant object and/or motion activity, are assigned to a base (e.g., lowest) layer of the dynamic encoding prediction structure, whereas other video frames are assigned to one or more higher layers of the dynamic encoding prediction structure. As disclosed in further detail below, the reference frames for encoding and decoding video frames assigned to the base (e.g., lowest) layer of the dynamic encoding prediction structure are restricted to other, preceding video frames also at that same base (e.g., lowest) layer of the dynamic encoding prediction structure. As such, video frames assigned to higher levels of the dynamic encoding prediction structure can be skipped without impacting the decoding of the video frames at that base (e.g., lowest) layer of the dynamic encoding prediction structure.

Some example enhanced video codecs disclosed herein include example enhanced encoders to compute a score, referred to as a suitable-for-inference-factor (SIF) score, for a given video frame that can be used to determine whether the video frame is likely to be useful for AI processing. As disclosed in further detail below, some example enhanced encoders compute a SIF score for a given video frame based on AI metric(s) associated with the video frame (e.g., such as when the video frame corresponds to an output of an AI algorithm for which one or more AI inference outputs are available), motion information associated with the video frame (e.g., such as motion vector(s) and/or other motion characteristic(s) determined as part of encoding one or more video frames preceding the given video frame), a frame difference metric (such as a sum of absolute differences computed between pixels of the given video frame and corresponding pixels of a preceding frame), etc. Some example enhanced encoders assign video frames to layers of the dynamic encoding prediction structure based on their respective SIF scores. Some example enhanced encoders cause the SIF score and/or layer assignment information for a given video frame to be encoded in the video stream as metadata along with the video frame. For example, the layer assignment information for a given video frame may specify the particular layer of the dynamic encoding prediction structure to which the video frame is assigned and/or the reference frame(s) of that assigned layer (and any lower layers) on which the given video frame depends.

Some example enhanced video codecs disclosed herein include example enhanced decoders that utilize the SIF score metadata and/or layer assignment metadata provided for a given video frame in an encoded video stream to determine whether the given video frame should be decoded or skipped. As such, example enhanced video codecs disclosed herein can save compute and/or memory resources by focusing video decoding on video frames that are likely to be useful for AI processing in a compute node, and skipping decoding of video frames that are unlikely to be useful for AI processing. Some enhanced video codecs instruct a video decoder to decode or skip a given video frame based on the particular layer of the dynamic encoding prediction structure to which the video frame is assigned. For example, some enhanced video codecs instruct a video decoder to decode video frames assigned to a base (e.g., lowest) layer of the dynamic encoding prediction structure, and to skip decoding of video frames assigned to a higher layer of the dynamic encoding prediction structure. Additionally or alternatively, some example enhanced video codecs instruct a video decoder to decode or skip a given video frame based on the SIF score of the video frame. For example, some enhanced video codecs instruct a video decoder to decode video frames having SIF scores that satisfy a threshold, and to skip decoding of video frames having SIF scores that do not satisfy the threshold. In examples disclosed herein, video frames that are decoded are provided as inputs for AI processing on the compute node, whereas video frames for which decoding is skipped are not provided as inputs for AI processing. As such, at least some example enhanced video codecs disclosed herein can not only save compute and/or memory resources associated with video decoding, but can also save compute and/or memory resources associated with AI processing.

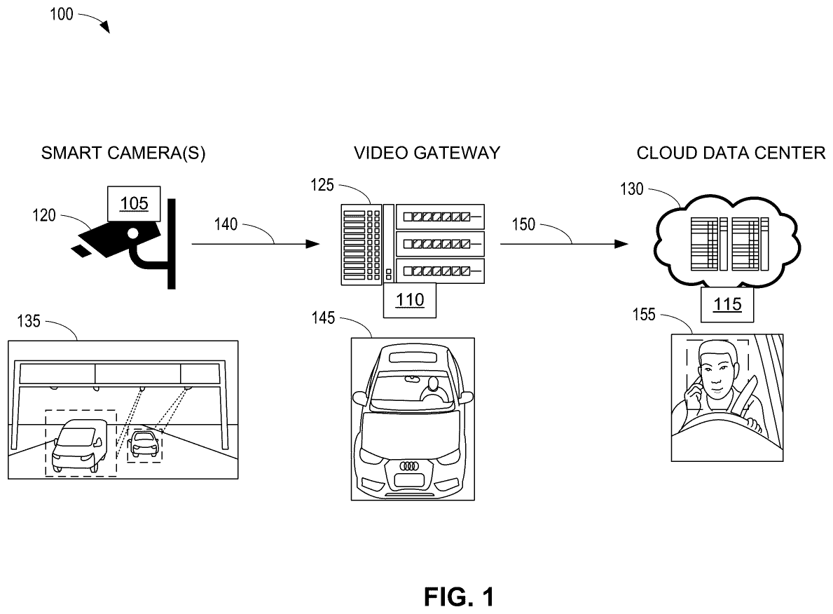

Turning to the figures, FIG. 1 is a block diagram of example distributed AI application pipeline 100 including example video codecs 105, 110 and 115 for AI applications as disclosed herein. In the illustrated example of FIG. 1, the distributed AI application pipeline 100 is tailored for video analytics applications, such as video surveillance applications. As such, the example distributed AI application pipeline 100 includes one or more example smart cameras 120, an example video gateway 125 and an example cloud data center 130. In the illustrated example, the smart camera(s) 120 correspond to any number(s) and/or type(s) of cameras, imaging devices, imaging sensors, etc., capable of capturing images of a monitored environment and detecting objects, events, activities, etc., in the environment. For example, the smart camera(s) 120 may be traffic surveillance camera(s) positioned to detect license plates of vehicles traveling on a highway (e.g., for toll collection, traffic monitoring, speed violation detection, accident detection, etc.).

In the illustrated example, a given smart camera 120 captures input video frames in a camera field-of-view and performs AI processing to detect vehicles (e.g., automobiles, trucks, motorcycles, etc.) in the input frames. For example, the smart camera 120 may implement one or more AI algorithms, neural networks, machine learning models, etc., to detect vehicles in the input frames. In the illustrated example, the smart camera 120 includes the example video codec 105 to encode output video frames, such as an example output video frame 135, in which detected vehicle(s) were embedded into an example encoded video stream 140 to be transmitted to the next compute node in the AI pipeline 100, which is the video gateway 125. As disclosed in further detail below, the video codec 105 implements one or more example enhanced video encoders that support improved (e.g., more efficient, less resource intensive, etc.) AI processing at the next compute node in the AI pipeline 100, which is the video gateway 125 in the illustrated example.

In the illustrated example, the video gateway 125 corresponds to any number(s) and/or type(s) of gateways, network video recorders, edge devices, etc., capable of receiving encoded video streams from one or more of the smart camera(s) 120 and processing those streams to detect further information in the encoded video frames of those video streams. For example, the video gateway 125 may be a network video recorder and/or other edge device that decodes the encoded video stream 140 to obtain decoded video frames, and performs AI processing to detect license plate(s), vehicle make(s), vehicle model(s), etc., for vehicles detected in the decoded video frames. For example, the video gateway 125 may implement one or more AI algorithms, neural networks, machine learning models, etc., to detect the license plate(s), the vehicle make(s), the vehicle model(s), etc., for the vehicles detected in the decoded video frames.

In the illustrated example, the video gateway 125 includes the video codec 110 to decode the encoded video stream 140 to obtain the decoded video frames for AI processing. As disclosed in further detail below, the video codec 110 implements one or more example enhanced video decoders that support improved (e.g., more efficient, less resource intensive, etc.) AI processing at the video gateway 125. In the illustrated example, the video gateway 125 also uses the video codec 110 to encode output video frames, such as an example output video frame 145, in which further descriptive information, such vehicle license plate(s), vehicle make(s), vehicle model(s), etc., was detected into an example encoded video stream 150 to be transmitted to the next compute node in the AI pipeline 100, which is the cloud data center 130. In some examples, the output video frames may be cropped and/or otherwise modified to focus on regions of interest relevant to the next compute node in the AI pipeline 100. As disclosed in further detail below, the video codec 110 implements one or more example enhanced video encoders that support improved (e.g., more efficient, less resource intensive, etc.) AI processing at the next compute node in the AI pipeline 100, which is the cloud data center 130 in the illustrated example.

In the illustrated example, the cloud data center 130 corresponds to any number(s) and/or type(s) of data centers, cloud servers, computers, compute devices, etc., capable of receiving encoded video streams from one or more video gateway(s) 125 and processing those streams to detect further information in the encoded video frames of those video streams. For example, the cloud data center 130 may be a data center, server, etc., that decodes the encoded video stream 150 to obtain decoded video frames, and performs AI processing to perform facial detection on video frames that depict vehicles with identifiable detect license plate(s), vehicle make(s), vehicle model(s), etc., to detect and identify driver(s) of those vehicles. For example, the cloud data center 130 may implement one or more AI algorithms, neural networks, machine learning models, etc., that perform facial detection to detect human faces in video frames that depict vehicles with identifiable license plate(s), vehicle make(s), vehicle model(s), etc.

In the illustrated example, the cloud data center 130 includes the video codec 115 to decode the encoded video stream 150 to obtain the decoded video frames for AI processing. As disclosed in further detail below, the video codec 115 implements one or more example enhanced video decoders that support improved (e.g., more efficient, less resource intensive, etc.) AI processing at the cloud data center 130. In the illustrated example, the cloud data center 130 also uses the video codec 110 to encode output video frames, such as an example output video frame 155, in which faces were detected for subsequent output, storage, etc. In some examples, the output video frames may be cropped and/or otherwise modified to focus on regions of interest (e.g., such a regions containing detected faces). As can be seen from the example of FIG. 1, video data may be decoded and encoded at multiple stages in the end-to-end distributed media analytics pipeline 100. As such, example enhanced video encoders and video decoders disclosed herein have the potential to improve AI processing at multiple stages of the pipeline 100.

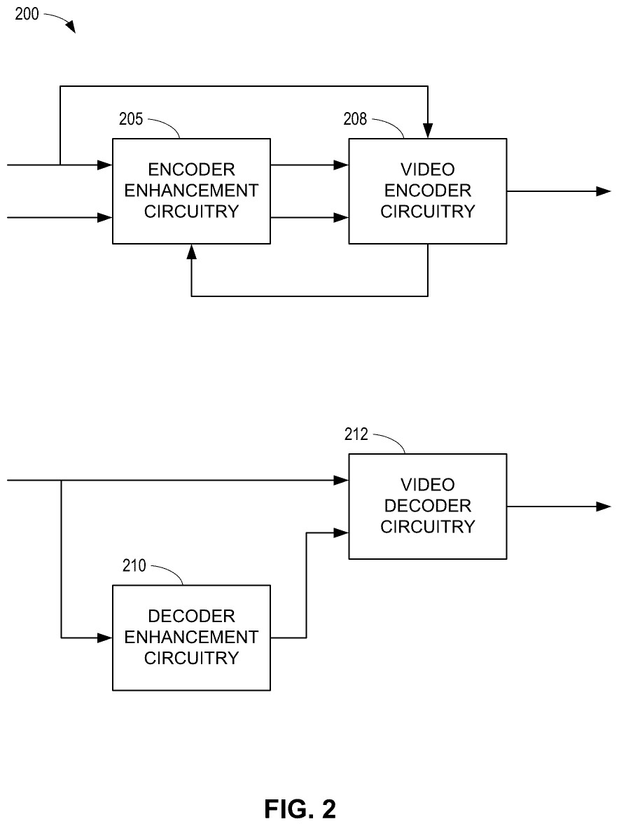

FIG. 2 is a block diagram of an example video codec 200 that can be used to implement one or more of the example video codecs 105, 115 and/or 120 of FIG. 1. The video codec 200 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the video codec 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

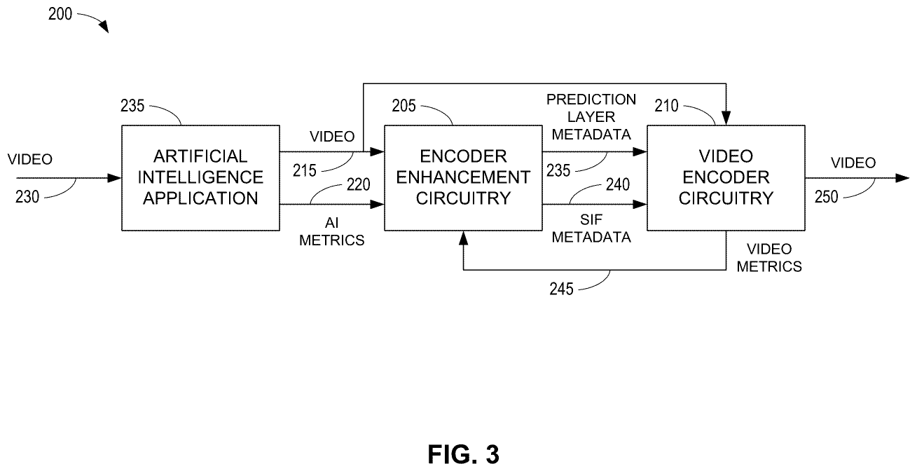

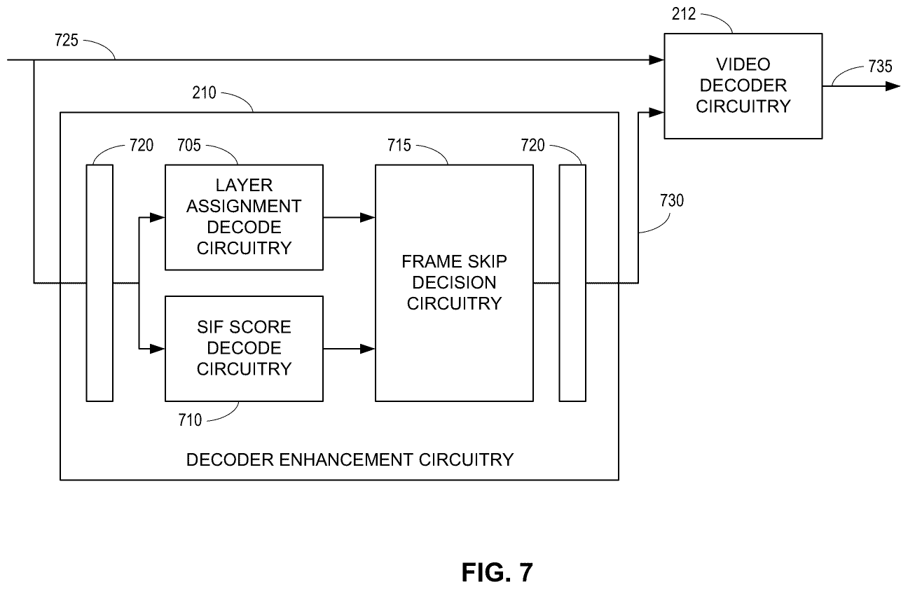

The example video codec 200 of FIG. 2 includes example encoder enhancement circuitry 205 and example video encoder circuitry 208 to encode input video frames into an output encoded video bitstream. The example video codec 200 of FIG. 2 also includes example decoder enhancement circuitry 210 and example video decoder circuitry 212 to decode an input encoded video bitstream into output decoded video frames. Further implementation and operation details concerning the encoder enhancement circuitry 205 and the video encoder circuitry 208 are provided below in the context of the description of FIG. 3. Further implementation and operation details concerning the decoder enhancement circuitry 210 and the video decoder circuitry 212 are provided below in the context of the description of FIG. 7.

FIG. 3 is a block diagram illustrating the example encoder enhancement circuitry 205 and the example video encoder circuitry 208 included in the example video codec of FIG. 2. The encoder enhancement circuitry 205 and/or the video encoder circuitry 208 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the encoder enhancement circuitry 205 and/or the video encoder circuitry 208 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

In the example of FIG. 3, the encoder enhancement circuitry 205 receives or otherwise obtains example video frames 215 to be encoded, as well as example AI metrics 220, from an example AI application 225. In the illustrated example, the AI application 225 corresponds to any AI processing, neural network(s), machine learning model(s), etc., implemented by or otherwise associated with a compute node that implements, includes, or is otherwise associated with the encoder enhancement circuitry 205 and the video encoder circuitry 208. For example, if the encoder enhancement circuitry 205 and the video encoder circuitry 208 correspond to implementation in the video codec 105, the AI application 225 can correspond to the AI processing performed by a smart camera 120. As another example, if the encoder enhancement circuitry 205 and the video encoder circuitry 208 correspond to implementation in the video gateway 125, the AI application 225 can correspond to the AI processing performed by the video gateway 125. As yet another example, if the encoder enhancement circuitry 205 and the video encoder circuitry 208 correspond to implementation in the cloud data center 130, the AI application 225 can correspond to the AI processing performed by the cloud data center 130.

In the illustrated example, the AI application 225 processes example input video frames 230 to produce the output video frames 215 and the AI metrics 220. For example, if the AI application 225 corresponds to a smart camera 120, the input video frames 230 can correspond to video frames captured by the camera 120, the AI metrics 220 can correspond to object (e.g., vehicle) detection and classification information, and the output video frames 215 can correspond to cropped regions of those input frames 230 in which objects (e.g., vehicles) were detected and classified by the AI application 225. As another example, if the AI application 225 corresponds to the video gateway 125, the input video frames 230 can correspond to decoded video frames obtained from the smart camera 120 (e.g., corresponding to cropped regions of captured video frames in which vehicles were detected and classified), the AI metrics 220 can correspond to object (e.g., license plate) detection and classification information, and the output video frames 215 can correspond to cropped regions of those input frames 230 in which objects (e.g., license plates) were detected and classified by the AI application 225. As yet another example, if the AI application 225 corresponds to the cloud data center 130, the input video frames 230 can correspond to decoded video frames obtained from the video gateway 125 (e.g., corresponding to cropped regions of video frames in which license plates were detected and classified), the AI metrics 220 can correspond to object (e.g., facial) detection and classification information, and the output video frames 215 can correspond to cropped regions of those input frames 230 in which objects (e.g., faces) were detected and classified by the AI application 225.

The encoder enhancement circuitry 205 of the illustrated example accesses a video frame 215 to be encoded and determines example prediction layer metadata 235 and example SIF metadata 240 for that video frame 215. In the illustrated example, the prediction layer metadata 235 specifies an assignment of the video frame 215 to particular layer of a dynamic encoding prediction structure. The dynamic encoding prediction structure defines decoding priorities and dependencies of video frames to be encoded by the video encoder circuitry 208. For example, a base (e.g., lowest) layer of the dynamic encoding prediction structure may be associated with frames having a highest decoding priority, such as frames that are likely to be useful for AI processing in a next compute node of an AI pipeline, such as the AI pipeline 100. Higher layers of the dynamic encoding prediction structure may be associated with decreasing decoding priority, such as frames that are unlikely to be useful for AI processing in a next compute node of the AI pipeline. In some examples, a highest layer of the dynamic encoding prediction structure is associated with frames having a lowest decoding priority, such as frames that can be skipped by the next compute node of the AI pipeline. Further details concerning the prediction layer metadata 235 and the dynamic encoding prediction structure are provided below.

In the illustrated example, the SIF metadata 240 includes a SIF score for the accessed video frame 215 to be encoded. In some examples, the SIF score represents a likelihood that the video frame 215 to be encoded will be useful (or, in other words, suitable for inference) in the context of the AI processing performed at the next compute node of the AI pipeline, such as the AI pipeline 100. For example, SIF scores may cover a possible range of values, such as 0 to 1, 0 to 100, etc., or may cover a set of categories, such as (“low,” “medium,” “high”), (“poor,” “average,” “good”), etc.

In the illustrated example, the encoder enhancement circuitry 205 determines the prediction layer metadata 235 and the SIF metadata 240 based on one or more AI metrics and/or video metrics, such as one or more of the AI metrics 220 from the AI application 225, one or more example video metrics 245 obtained from the video encoder circuitry 208 for preceding video frames that were encoded by the video encoder circuitry 208, etc. Additionally or alternatively, in some examples, the encoder enhancement circuitry 205 implements its own AI metric generation algorithm(s) that process the accessed video frame 215 and/or one or more preceding video frames previously encoded by the video encoder circuitry 208 into an example output video stream 250 to generate one or more AI metrics to be used to determine the prediction layer metadata 235 and/or the SIF metadata 240. Additionally or alternatively, in some examples, the encoder enhancement circuitry 205 implements its own video metric generation algorithm(s) that process the accessed video frame 215 and/or one or more preceding video frames previously encoded by the video encoder circuitry 208 to the output video stream 250 to generate one or more video metrics to be used to determine the prediction layer metadata 235 and/or the SIF metadata 240. Further details concerning determining the prediction layer metadata 235 and the SIF metadata 240 are provided below.

In the illustrated example, the video encoder circuitry 208 encodes the accessed video frame 215 based on the prediction layer metadata 235 to produce the encoded video stream 250. For example, the video encoder circuitry 208 can implement any video encoder algorithm or combination of video encoder algorithms that support an encoder prediction structure having multiple layers. However, rather than assigning an input video frame to a layer of the prediction structure based on a standardized approach defined for the particular video encoder algorithm, such as based on the sequence or picture number of the input video frame, the video encoder circuitry 208 encodes the accessed video frame 215 at the specific layer of the prediction structure specified in the prediction layer metadata 235.

Furthermore, in some examples, the video encoder circuitry 208 encodes the prediction layer metadata 235 and the SIF metadata 240 for the resulting encoded video frame in the output video stream 250 for use by the next compute node in the AI pipeline when decoding the video stream 250. Also, in some examples, the video encoder circuitry 208 identifies the reference frame(s) on which the encoded video frame depends in its prediction layer metadata 235.

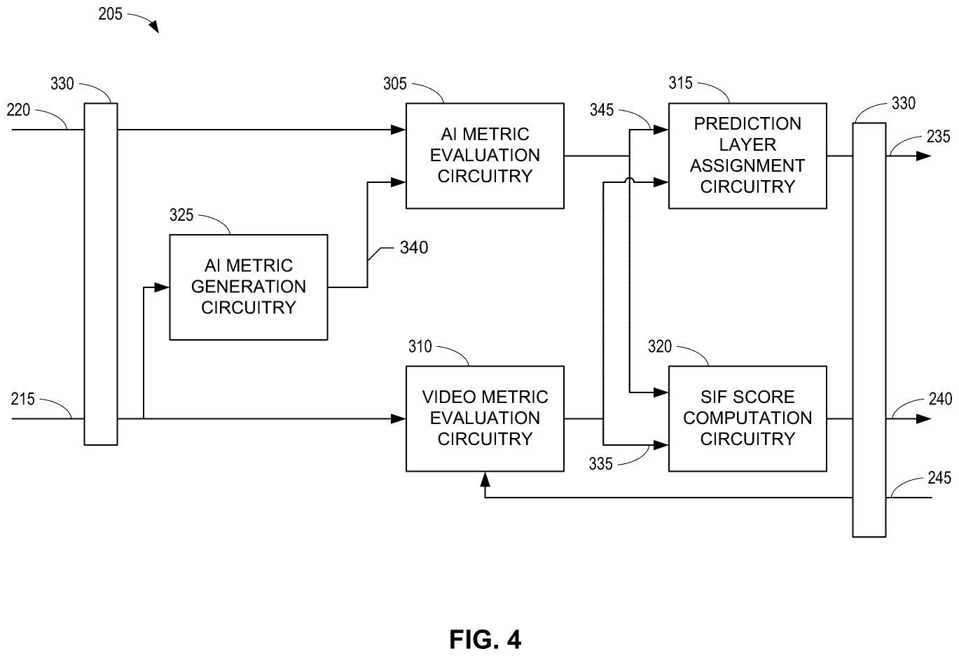

FIG. 4 is a block diagram of an example implementation of the encoder enhancement circuitry 205 of FIGS. 2 and/or 3. The encoder enhancement circuitry 205 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the encoder enhancement circuitry 205 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example encoder enhancement circuitry 205 of FIG. 4 includes example AI metric evaluation circuitry 305, example video metric evaluation circuitry 310, example prediction layer assignment circuitry 315, example SIF score computation circuitry 320, example AI metric generation circuitry 325, example interface circuitry 330. In the illustrated example, the interface circuitry 330 receives, reads, accesses, etc., the video frames 215 to be encoded by the video encoder circuitry 208. The interface circuitry 330 also receives, reads, accesses, etc., the AI metrics 220 and the video metrics 245 associated with the video frames 215. For example, the video frames 215 and AI metrics 220 can be obtained from the AI application 225 on the compute device the includes the encoder enhancement circuitry 205, and the video metrics 245 can be obtained from the video encoder circuitry 208 on the compute device the includes the encoder enhancement circuitry 205.

In the illustrated example, the video metric evaluation circuitry 310 processes the video metrics 245 and/or video frames 215 to determine example filtered video metrics 335 to be used for prediction layer assignment of the video frames 215, SIF score computation for the video frames 215, etc. For example, the video metric evaluation circuitry 310 may include one or more of the input video metrics 245 for a given video frame 215 in the filtered video metric(s) 335 for that given frame. Additionally or alternatively, in some examples, the video metric evaluation circuitry 310 processes one or more of the input video frames 215 and/or one or more of the input video metrics 245 to determine the filtered video metric(s) 335 for that given frame.

For example, the input video metric(s) 245 associated with a given video frame 215 to be encoded may include motion vector information (e.g., motion vectors) determined by the video encoder circuitry 208 when encoding one or more video frames preceding the given video frame 215 to be encoded. Because adjacent video frames tend to have similar motion characteristics, the motion vector information for video frame(s) preceding the given video frame 215 can be used to approximate the motion vector information for the given video frame. In some examples, the input video metric(s) 245 associated with the given video frame 215 may include other statistics for the encoded video frame(s) preceding the given video frame 215 to be encoded. For example, such other statistics may include one or more of macroblock prediction type, such as interblock, intrablock, etc., macroblock skip information, etc. In some examples, the video metric evaluation circuitry 310 includes the motion vector information and/or other frame statistics associated with given video frame 215 to be encoded in the filtered video metric(s) 335 for that given frame without further processing. In some examples, the video metric evaluation circuitry 310 evaluates the motion vector information and/or other frame statistics associated with given video frame 215 to be encoded to determine a filtered video metric 335 corresponding to a motion classification for the given video frame. For example, the video metric evaluation circuitry 310 may compare the motion vector information for the encoded video frame(s) preceding the given video frame 215 to one or more thresholds to classify the given video frame into one or a set of possible motion classifications. In some examples, the possible motion classifications may be numeric values in a range that represents no motion at one end of the range and high motion at the other end of the range. In some examples, the possible motion classifications may be discrete classifications, such as “no motion,” “moderate motion,” “high motion,” etc. In some examples, the video metric evaluation circuitry 310 includes both the input motion vector information and the determined motion classification for the given video frame 215 in the filtered video metric(s) 335 for that given frame.

In some examples, the video metric evaluation circuitry 310 evaluates a given video frame 215 to be encoded and/or one or more preceding video frames 215 to determine one or more other filtered video metrics 335 for the given video frame 215. For example, the video metric evaluation circuitry 310 may evaluate the pixels of the given video frame 215 to estimate a quality of the given video frame 215 (e.g., by estimating a blur factor associated with the given frame), an amount of information conveyed by the given video frame 215 (by determining whether the given frame is a blank/static frame, or contains pixels of varying color, intensity, etc.), etc. In some examples, the video metric evaluation circuitry 310 compares the given video frame 215 to encoded with one or more preceding video frames 215 to determine a frame difference metric for the given video frame. For example, the video metric evaluation circuitry 310 may compute the frame difference metric for the given video frame 215 to be a sum of absolute differences between pixels of the given video frame 215 and corresponding pixels of a preceding video frame 215.

In the illustrated example, the AI metric evaluation circuitry 305 processes the input AI metrics 220 from the AI application 225 and/or example AI suitability metrics 340 from the AI metric generation circuitry 325 to determine example filtered AI metrics 345 to be used for prediction layer assignment of the video frames 215, SIF score computation for the video frames 215, etc. For example, the AI metric evaluation circuitry 305 may include one or more of the AI metrics 220 for a given video frame 215 in the filtered AI metric(s) 345 for that given frame. Additionally or alternatively, in some examples, the AI metric evaluation circuitry 305 may include one or more the AI suitability metrics 340 obtained from the AI metric generation circuitry 325 for a given video frame 215 in the filtered AI metric(s) 345 for that given frame.

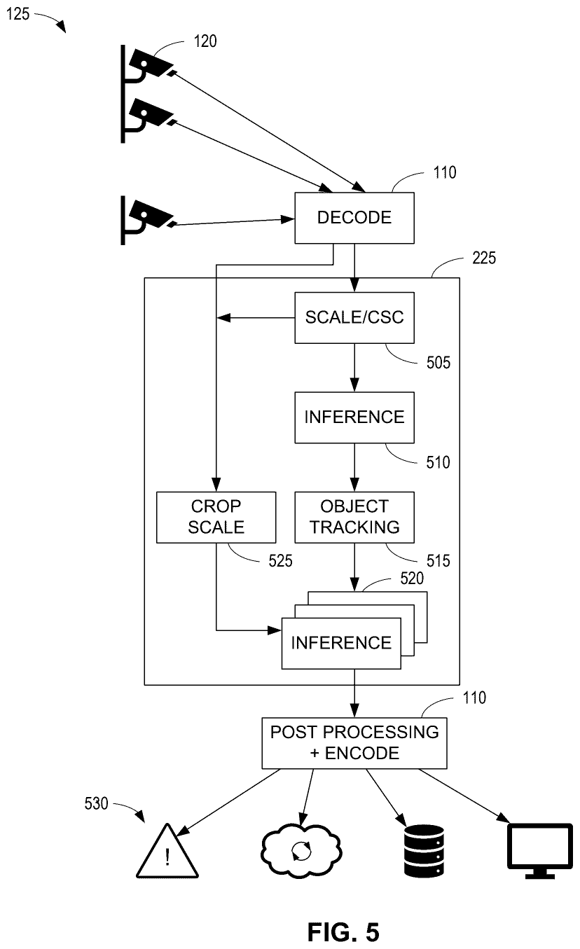

For example, the input AI metric(s) 220 associated with a given video frame 215 to be encoded may include object detection inference metrics, object classification inference metrics, etc., determined by the AI application 225 for the given video frame 215. An example implementation of the AI application 225 that determines example object detection inference metrics and object classification inference metrics for a video frame is illustrated in FIG. 5. In the illustrated example of FIG. 5, the AI application 225 is implemented by the video gateway 125. However, in other examples, the AI application 225 of the illustrated example could be implemented by any other compute node, compute device, etc.

The example AI application 225 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the AI application 225 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

In the illustrated example of FIG. 5, the video codec 110 of the video gateway 125 decodes the video stream(s) from the smart camera(s) 120 and provides the resulting decoded video frames as input video frames to the AI application 225. The AI application 225 of the illustrated example includes first example preprocessing circuitry 505 to perform scaling and color space conversion on the input video frames. The AI application 225 of the illustrated example includes first example inference circuitry 510 that performs object detection on the preprocessed video frames to determine object detection inference metrics for respective video frames input to the AI application 225. For example, the first inference circuitry 510 may implement one or more neural networks, one or more neural network layers, one or more machine learning models, etc., to detect objects depicted in the respective video frames input to the AI application 225 and output corresponding object detection inference metrics. In some examples, the object detection inference metrics specify a number of objects, if any, detected in a given input video frame, locations (e.g., pixel locations, grid locations, etc.) of the object(s), if any, detected in the given input video frame, etc.

The AI application 225 of the illustrated example includes example object tracking circuitry 515 to track detected objects across multiple input video frames. By employing the object tracking circuitry 515, the AI application 225 can skip processing some of the input frames to reduce the processing rate of the AI application. For example, if the video frames at the input to the AI application 225 have a rate of 30 frames per second (fps), the object tracking circuitry 515 may enable the AI application 225 to operate on every other frame for a processing rate of 15 fps, or every third frame for a processing rate of 10 fps, etc.

The AI application 225 of the illustrated example includes second example inference circuitry 520 that performs object classification on preprocessed video frames to determine object classification inference metrics for respective video frames input to the AI application 225. In the illustrated example, the AI application 225 includes second example preprocessing circuitry 525 to further crop and scale the frames from the first preprocessing circuitry 505 to generate the preprocessed frames to be input to the second inference circuitry 520. The second inference circuitry 520 may implement one or more neural networks, one or more neural network layers, one or more machine learning models, etc., that operate on the preprocessed frames to classify object(s) depicted in the respective video frames input to the AI application 225 and output corresponding object classification inference metrics. In some examples, the object classification inference metrics for a given input video frame include a set of classification scores for each object detected in that input video frame. For example, the second inference circuitry 520 may classify detected objects based on a set of possible classes, categories, etc., associated respectively with the set of classification scores. In some such examples, the set of classification scores output by the second inference circuitry 520 for an object detected in a given input video frame includes a first classification score representing a probability, likelihood, etc., that the object belongs to a first possible class, category, etc., a second classification score representing a probability, likelihood, etc., that the object belongs to a second possible class, category, etc., a third classification score representing a probability, likelihood, etc., that the object belongs to a third possible class, category, etc., and so on.

In the illustrated example of FIG. 5, the video codec 110 of the of the video gateway 125 encodes video frames output from the AI application 225 into an encoded video bitstream based the example disclosed herein. In some examples, the encoded video bitstream from the video codec 110 can be provided to the next compute node in an AI pipeline, such as the cloud data center 130 in the AI pipeline 100. In some examples, the encoded video bitstream from the video codec 110 may be used to generate one or more example outputs 530, such as output video on a display, output video to be stored locally and/or in the cloud, one or more alerts, etc.

Returning to FIG. 4, the AI metric evaluation circuitry 305 includes the object detection inference metric(s) and the object classification inference metric(s) from the input AI metrics 220 for a given video frame 215 in the filtered AI metric(s) 345 for that given frame. In some examples, the encoder enhancement circuitry 205 includes the AI metric generation circuitry 325 to additionally or alternatively generate example AI suitability metric(s) 340 for a given video frame 215, which can be included in the filtered AI metric(s) 345 for that given frame. In some examples, the AI metric generation circuitry 325 implements one or more neural networks, one or more neural network layers, one or more machine learning models, etc., trained to generate one or more AI suitability metric(s) 340 that predict a likelihood that the given video frame 215 will be suitable (e.g., useful) for AI processing at a subsequent (e.g., downstream) compute node in an AI pipeline, such as the AI pipeline 100. For example, the AI suitability metric(s) 340 for a given video frame 215 may include one or more probabilities that the given frame 215 exhibits one or more characteristics (e.g., image quality, motion, depicted shapes, etc.) shared with video frames that typically produce useful AI results at the subsequent compute node in the AI pipeline.

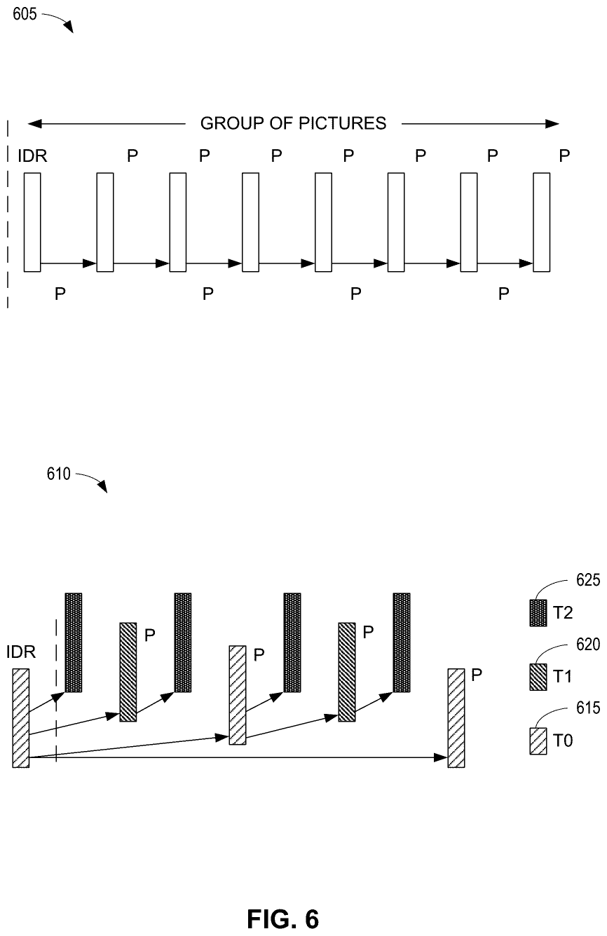

In the illustrated example of FIG. 4, the prediction layer assignment circuitry 315 determines the prediction layer metadata 235 for a given input video frame 215 to be encoded. The prediction layer metadata 235 specifies an assignment of the video frame 215 to a particular layer of a dynamic encoding prediction structure. The dynamic encoding prediction structure defines decoding priorities and dependencies of video frames to be encoded by the video encoder circuitry 208. Example encoding prediction structures are illustrated in FIG. 6.

FIG. 6 illustrates an example flat encoding prediction structure 605 and an example dynamic encoding prediction structure 610. The flat encoding prediction structure 605 includes one prediction layer and all video frames in a group of pictures (GOP) are assigned to that same layer for encoding. In the flat encoding prediction structure 605, a first frame in the GOP is assigned to be the instantaneous decoder refresh (IDR) frame for the GOP, and each subsequent frame in the GOP is encoded using the preceding frames as reference frames. In other words, in the flat encoding prediction structure 605, each encoded frame depends on the preceding encoded frames of the GOP (e.g., as illustrated by the directed lines in the flat encoding prediction structure 605). As such, to decode a given frame based on flat encoding prediction structure 605, all preceding frames of the GOP must be decoded as they are used as reference frames to decode the given frame.

In contrast, the dynamic encoding prediction structure 610 includes multiple example prediction layers 615-625, also referred to as temporal layers, to which video frames in a GOP can be assigned. In the dynamic encoding prediction structure 610, a first frame in the GOP is assigned to be the IDR frame for the GOP, and subsequent frames in the GOP can be assigned to any of the prediction layers 615-625 of the dynamic encoding prediction structure 610. Furthermore, in the dynamic encoding prediction structure 610, a subsequent frame of the GOP is encoded using just one or more of the preceding frames assigned to the same layer as the subsequent frame and/or assigned to a lower layer of the dynamic encoding prediction structure 610. In other words, in the dynamic encoding prediction structure 610, each encoded frame depends at most on the preceding encoded frames of the GOP that are assigned to the same or lower layers of the dynamic encoding prediction structure 610 (e.g., as illustrated by the directed lines in the dynamic encoding prediction structure 610). As such, to decode a given frame based on dynamic encoding prediction structure 610, just the preceding frames of the GOP on the same or lower layers of the dynamic encoding prediction structure 610 may need to be decoded.

Returning to FIG. 4, the prediction layer assignment circuitry 315 utilizes the dynamic encoding prediction structure 610 and assigns a given input video frame 215 to one of the prediction layers prediction layers 615-625 of the dynamic encoding prediction structure 610 based on the filtered video metric(s) 335 and/or the filtered AI metric(s) 345 associated with that given video frame 215. In the illustrated example, the prediction layer assignment circuitry 315 utilizes the base (e.g., lowest) layer 615 of the dynamic encoding prediction structure 610 to encode frames having a highest decoding priority, such as frames that are likely to be useful for AI processing in a next compute node of an AI pipeline, such as the AI pipeline 100. In the illustrated example, the prediction layer assignment circuitry 315 utilizes the next higher layer 620 of the dynamic encoding prediction structure 610 to encode frames with lower decoding priority, such as frames that are less likely to be useful for AI processing in a next compute node of the AI pipeline. In the illustrated example, the prediction layer assignment circuitry 315 utilizes the highest layer 625 of the dynamic encoding prediction structure 610 to encode frames having a lowest decoding priority, such as frames that can be skipped by the next compute node of the AI pipeline.

As noted above, the prediction layer assignment circuitry 315 assigns a given input video frame 215 to one of the prediction layers prediction layers 615-625 of the dynamic encoding prediction structure 610 based on the filtered video metric(s) 335 and/or the filtered AI metric(s) 345 associated with that given video frame 215. In some examples, the prediction layer assignment circuitry 315 assigns a given input video frame 215 to one of the prediction layers prediction layers 615-625 of the dynamic encoding prediction structure 610 based on the filtered video metric(s) 335 associated with that given video frame 215. In some examples, the prediction layer assignment circuitry 315 assigns a given input video frame 215 to one of the prediction layers prediction layers 615-625 of the dynamic encoding prediction structure 610 based on the filtered AI metric(s) 345 associated with that given video frame 215. In some examples, the prediction layer assignment circuitry 315 assigns a given input video frame 215 to one of the prediction layers prediction layers 615-625 of the dynamic encoding prediction structure 610 based on a combination (e.g., a weighted combination, such as a weighted average, a weighted vote, etc.) of the filtered video metric(s) 335 and the filtered AI metric(s) 345 associated with that given video frame 215.

For example, the prediction layer assignment circuitry 315 may assign a given input video frame 215 to one of the prediction layers prediction layers 615-625 of the dynamic encoding prediction structure 610 based on the object detection inference metric(s) and/or the object classification inference metric(s)/score(s) included in the filtered AI metric(s) 345 for the given video frame 215. For example, the prediction layer assignment circuitry 315 may assign the given input video frame 215 to the base (e.g., lowest) layer 615 of the dynamic encoding prediction structure 610 if the object detection inference metric(s) and the object classification inference metric(s)/score(s) for the given video frame 215 indicate that the set of zero or more objects detected in the given frame includes at least one object with a classification score that satisfies (e.g., meets or exceeds) a threshold. In some such examples, the prediction layer assignment circuitry 315 may assign the given input video frame 215 to the highest layer 625 of the dynamic encoding prediction structure 610 if the object detection inference metric(s) and the object classification inference metric(s)/score(s) for the given video frame 215 indicate that no object was detected in the given frame (e.g., the set of detected objects is empty), or that no object with a classification score that satisfies (e.g., meets or exceeds) a threshold was detected in the given input video frame 215. However, in some examples, the prediction layer assignment circuitry 315 may assign the given input video frame 215 to the intermediate layer 620 of the dynamic encoding prediction structure 610 if the object detection inference metric(s) and the object classification inference metric(s)/score(s) for the given video frame 215 indicate that that the set of zero or more objects detected in the given frame includes at least one object, but no object classification score satisfied (e.g., met or exceeded) the threshold.

In some examples, the, the prediction layer assignment circuitry 315 may assign a given input video frame 215 to one of the prediction layers prediction layers 615-625 of the dynamic encoding prediction structure 610 based on the filtered video metric(s) 335 in combination with the object detection inference metric(s) and the object classification inference metric(s)/score(s) included in the filtered AI metric(s) 345 for the given video frame 215. For example, the prediction layer assignment circuitry 315 may assign the given input video frame 215 to the base (e.g., lowest) layer 615 of the dynamic encoding prediction structure 610 if (i) the object detection inference metric(s) and the object classification inference metric(s)/score(s) for the given video frame 215 indicate that the set of zero or more objects detected in the given frame includes at least one object with a classification score that satisfies (e.g., meets or exceeds) a first threshold, and (ii) a frame difference metric or motion classification metric for the given input video frame 215 satisfies a second threshold. In some such examples, the prediction layer assignment circuitry 315 may assign the given input video frame 215 to the highest layer 625 of the dynamic encoding prediction structure 610 if (i) the object detection inference metric(s) and the object classification inference metric(s)/score(s) for the given video frame 215 indicate that no object was detected in the given frame (e.g., the set of detected objects is empty), and (ii) the frame difference metric or motion classification metric for the given input video frame 215 does not satisfy the second threshold. However, in some examples, the prediction layer assignment circuitry 315 may assign the given input video frame 215 to the intermediate layer 620 of the dynamic encoding prediction structure 610 if either (i) the object detection inference metric(s) and the object classification inference metric(s)/score(s) for the given video frame 215 indicate that that the set of zero or more objects detected in the given frame includes at least one object, but no object classification score satisfied (e.g., met or exceeded) the threshold, or (ii) the frame difference metric or motion classification metric for the given input video frame 215 satisfies the second threshold.

In some examples, the prediction layer assignment circuitry 315 may assign a given input video frame 215 to one of the prediction layers prediction layers 615-625 of the dynamic encoding prediction structure 610 based on the filtered video metric(s) 335 for the given video frame 215. For example, the prediction layer assignment circuitry 315 may assign the given input video frame 215 to the base (e.g., lowest) layer 615 of the dynamic encoding prediction structure 610 if (i) a frame difference metric for the given video frame satisfies (e.g., meets or exceeds) a first threshold and (ii) a motion classification metric for the given input video frame 215 satisfies a second threshold. In some such examples, the prediction layer assignment circuitry 315 may assign the given input video frame 215 to the highest layer 625 of the dynamic encoding prediction structure 610 if (i) the frame difference metric for the given video frame does not satisfy the first threshold and (ii) the motion classification metric for the given input video frame 215 does not satisfy second threshold. However, in some examples, the prediction layer assignment circuitry 315 may assign the given input video frame 215 to the intermediate layer 620 of the dynamic encoding prediction structure 610 if either (i) the frame difference metric for the given video frame satisfies (e.g., meets or exceeds) the first threshold or (ii) the motion classification metric for the given input video frame 215 satisfies the second threshold.

In the illustrated example of FIG. 4, the SIF score computation circuitry 320 determines a SIF score 240 for a given input video frame 215 based on the filtered video metric(s) 335 and/or the filtered AI metric(s) 345 associated with that given video frame 215. In some examples, the SIF score 240 determined by the SIF score computation circuitry 320 represents a probability, likelihood, etc., that the given video frame 215 to be encoded will be useful (or, in other words, suitable for inference) in the context of the AI processing performed at the next compute node of the AI pipeline, such as the AI pipeline 100. For example, SIF scores may cover a possible range of values, such as 0 to 1, 0 to 100, etc., or may cover a set of categories, such as (“low,” “medium,” “high”), (“poor,” “average,” “good”), etc.

In some examples, the SIF score computation circuitry 320 determines the SIF score 240 for a given input video frame 215 based on the filtered video metric(s) 335 associated with that given video frame 215. In some examples, the SIF score computation circuitry 320 determines the SIF score 240 based on the filtered AI metric(s) 345 associated with that given video frame 215. In some examples, the SIF score computation circuitry 320 determines the SIF score 240 based on a combination (e.g., a weighted combination, such as a weighted average, a weighted vote, etc.) of the filtered video metric(s) 335 and the filtered AI metric(s) 345 associated with that given video frame 215.

For example, the SIF score computation circuitry 320 may determine the SIF score 240 for a given input video frame 215 based on the object detection inference metric(s) and/or the object classification inference metric(s)/score(s) included in the filtered AI metric(s) 345 for the given video frame 215. For example, the SIF score computation circuitry 320 may determine the SIF score 240 for the given input video frame 215 based on (i) the set of zero or more objects detected in the given frame as represented by the object detection inference metric(s) and (ii) the corresponding set of classification scores as represented by the object classification inference metric(s)/score(s) included in the filtered AI metric(s) 345 for the given video frame 215. In some examples, the SIF score computation circuitry 320 may determine the SIF score 240 for the given input video frame 215 based on comparison of the set of zero or more objects (along with the corresponding set of classification scores) detected in the given frame with the set of zero or more objects (along with the corresponding set of classification scores) detected in the preceding frame. For example, the SIF score computation circuitry 320 may compare the set of zero or more objects detected in the given frame with the set of zero or more objects detected in the preceding frame. If the comparison indicates that at least one new object having a classification score that satisfies (e.g., meets or exceeds) a first threshold was detected in the given frame, the SIF score computation circuitry 320 may determine the SIF score 240 for the given input video frame 215 to be a high classification (e.g., “high,” “good,” etc.) and/or to be a value in a range that satisfies (e.g., meets or exceeds) a second threshold (e.g., a value in the range 0.8 to 1.0, a value in the range 75 to 100, etc.). However, if the comparison indicates that at least one new object was detected in the given frame, but no classification score satisfied (e.g., meets or exceeds) the first threshold, the SIF score computation circuitry 320 may determine the SIF score 240 for the given input video frame 215 to be a medium classification (e.g., “medium,” “average,” etc.) and/or to be a value in a range that is below the second threshold but satisfies (e.g., meets or exceeds) a third threshold (e.g., a value in the range 0.6 to 0.79, a value in the range 50 to 74, etc.). However, if the comparison indicates that no new objects were detected in the given frame, the SIF score computation circuitry 320 may determine the SIF score 240 for the given input video frame 215 to be a low classification (e.g., “low,” “poor,” etc.) and/or to be a value in a range that is below the third threshold (e.g., a value less than 0.6, a value less than 50, etc.).

In some examples, the SIF score computation circuitry 320 may determine the SIF score 240 for a given input video frame 215 based on the filtered video metric(s) 335 for the given video frame 215. For example, if (i) a frame difference metric for the given video frame satisfies (e.g., meets or exceeds) a first threshold and (ii) a motion classification metric for the given input video frame 215 satisfies a second threshold, the SIF score computation circuitry 320 may determine the SIF score 240 for the given input video frame 215 to be a high classification (e.g., “high,” “good,” etc.) and/or to be a value in a range that satisfies (e.g., meets or exceeds) a third threshold (e.g., a value in the range 0.8 to 1.0, a value in the range 75 to 100, etc.). However, if (i) the frame difference metric for the given video frame does not satisfy the first threshold and (ii) the motion classification metric for the given input video frame 215 does not satisfy the second threshold, the SIF score computation circuitry 320 may determine the SIF score 240 for the given input video frame 215 to be a low classification (e.g., “low,” “poor,” etc.) and/or to be a value in a lowest range that is below a lower fourth threshold (e.g., a value less than 0.6, a value less than 50, etc.). However, if either (i) the frame difference metric for the given video frame satisfies (e.g., meets or exceeds) the first threshold or (ii) the motion classification metric for the given input video frame 215 satisfies the second threshold, the SIF score computation circuitry 320 may determine the SIF score 240 for the given input video frame 215 to be a medium classification (e.g., “medium,” “average,” etc.) and/or to be a value in a range that is below the third threshold but satisfies (e.g., meets or exceeds) the fourth threshold (e.g., a value in the range 0.6 to 0.79, a value in the range 50 to 74, etc.).

In some examples, the SIF score computation circuitry 320 may determine the SIF score 240 for a given input video frame 215 based on a combination of the filtered video metric(s) 335 and the filtered AI metric(s) 345 associated with that given video frame 215. For example, the SIF score computation circuitry 320 may determine the SIF score 240 for the given input video frame 215 based a weighted average, a weighted vote, etc., of a combination of (i) the object detection inference metric(s) and/or the object classification inference metric(s)/score(s) included in the filtered AI metric(s) 345 for the given video frame 215, and (ii) the frame difference metric, motion vector information and/or the motion classification metric included in the filtered video metric(s) 335 for the given video frame 215.

In the illustrated example of FIG. 4, the interface circuitry 330 of the encoder enhancement circuitry 205 provides the prediction layer metadata 235 and the SIF score metadata 240 for a given input video frame 215 to the video encoder circuitry 208. As described above, the video encoder circuitry 208 encodes the given input video frame 215 into an encoded video bitstream based on the prediction layer of the dynamic encoding prediction structure 610 specified in the prediction layer metadata 235. In some examples, the video encoder circuitry 208 also encodes the prediction layer metadata 235 and the SIF score metadata 240 for the given input video frame 215 into the encoded video bitstream. In some examples, the video encoder circuitry 208 also modifies the prediction layer metadata 235 encoded in the encoded video bitstream to specify the reference frame(s) on which the given video frame 215 depends.

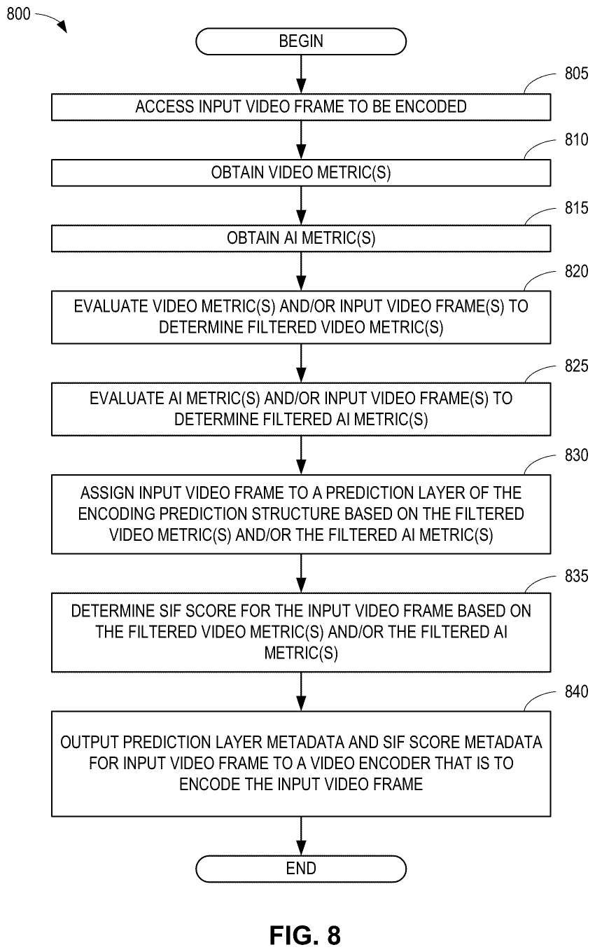

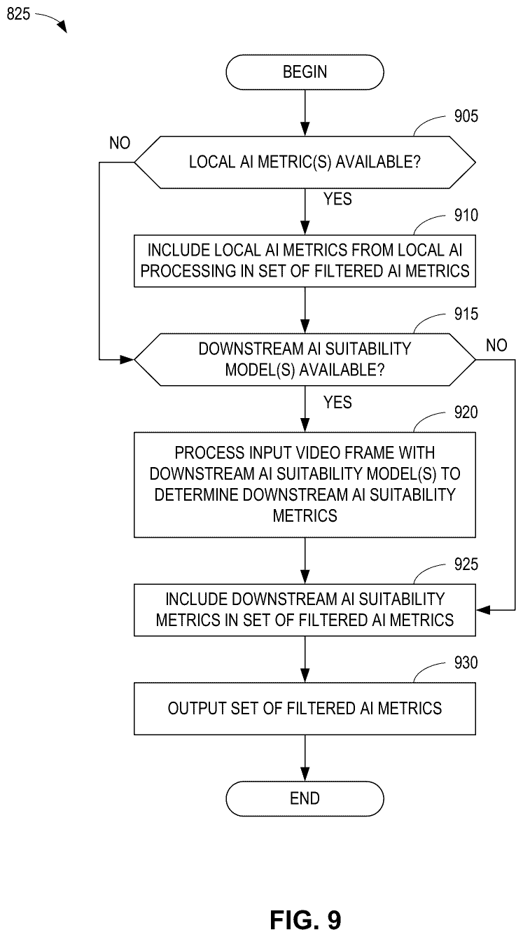

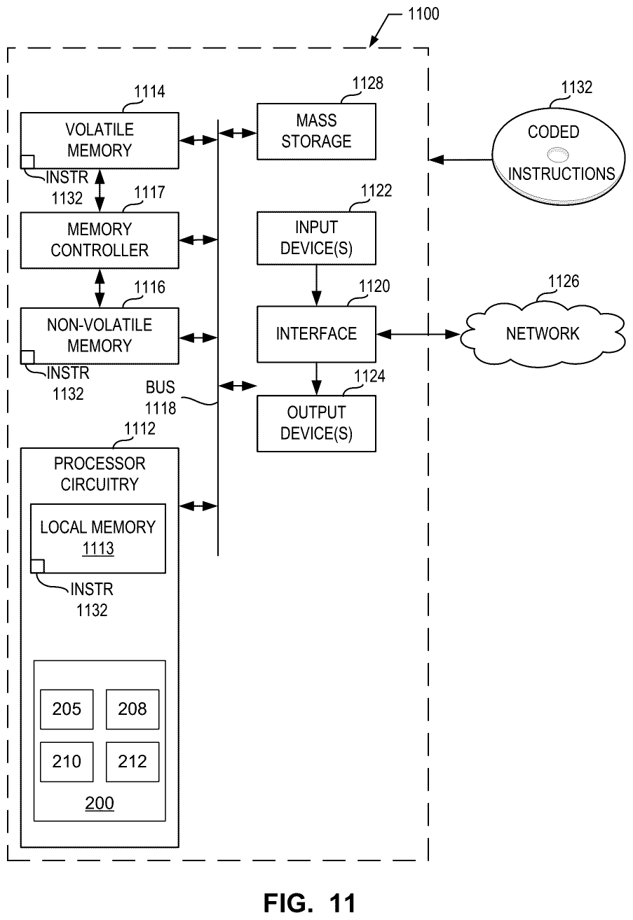

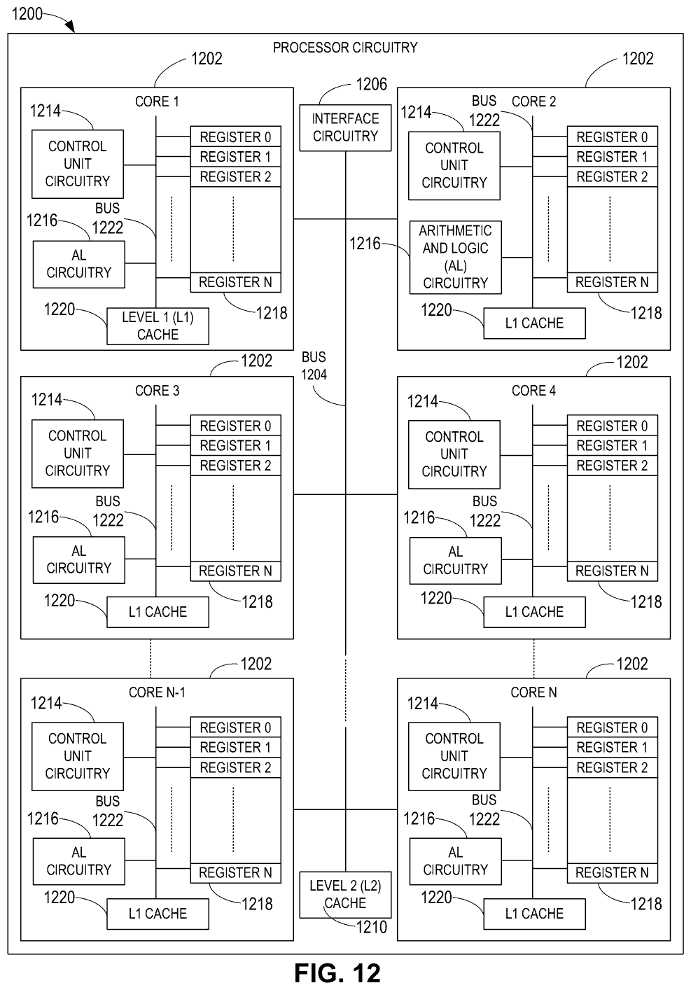

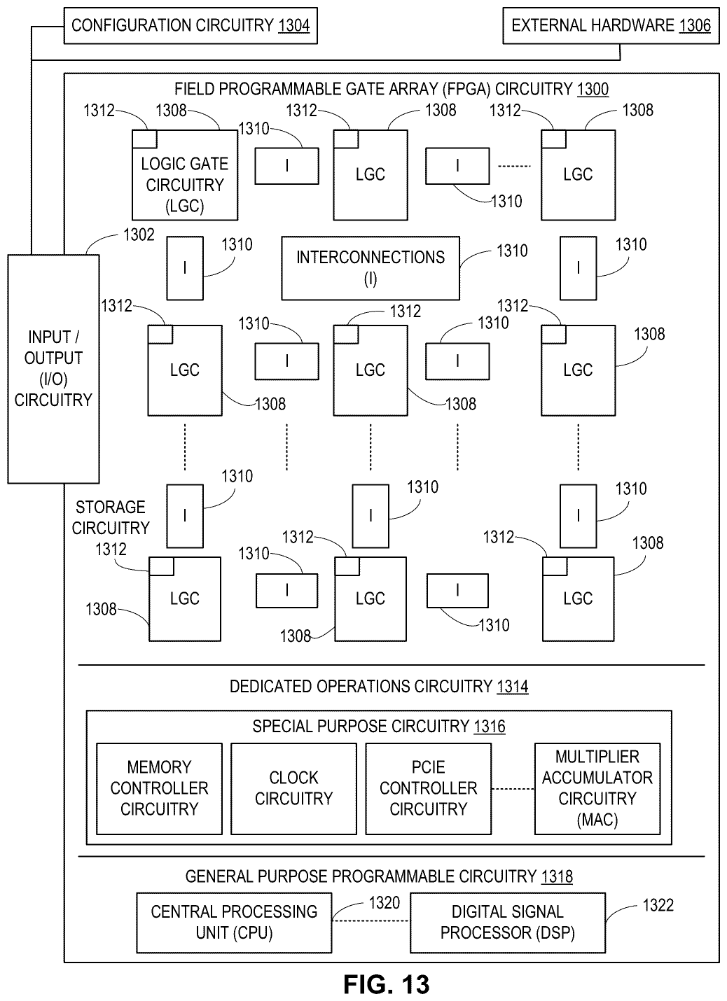

In some examples, the encoder enhancement circuitry 205 includes means for evaluating AI metrics. For example, the means for evaluating AI metrics may be implemented by the AI metric evaluation circuitry 305. In some examples, the AI metric evaluation circuitry 305 may be instantiated by programmable circuitry such as the example programmable circuitry 1112 of FIG. 11. For instance, the AI metric evaluation circuitry 305 may be instantiated by the example microprocessor 1200 of FIG. 12 executing machine executable instructions such as those implemented by at least blocks 815 and 825 of FIG. 8 and blocks 905-930 of FIG. 9. In some examples, the AI metric evaluation circuitry 305 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the AI metric evaluation circuitry 305 may be instantiated by any other combination of hardware, software, and/or firmware. For example, the AI metric evaluation circuitry 305 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the encoder enhancement circuitry 205 includes means for evaluating video metrics. For example, the means for evaluating video metrics may be implemented by the video metric evaluation circuitry 310. In some examples, the video metric evaluation circuitry 310 may be instantiated by programmable circuitry such as the example programmable circuitry 1112 of FIG. 11. For instance, the video metric evaluation circuitry 310 may be instantiated by the example microprocessor 1200 of FIG. 12 executing machine executable instructions such as those implemented by at least blocks 810 and 820 of FIG. 8. In some examples, the video metric evaluation circuitry 310 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the video metric evaluation circuitry 310 may be instantiated by any other combination of hardware, software, and/or firmware. For example, the video metric evaluation circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the encoder enhancement circuitry 205 includes means for assigning video frames to prediction layers. For example, the means for assigning video frames to prediction layers may be implemented by the prediction layer assignment circuitry 315. In some examples, the prediction layer assignment circuitry 315 may be instantiated by programmable circuitry such as the example programmable circuitry 1112 of FIG. 11. For instance, the prediction layer assignment circuitry 315 may be instantiated by the example microprocessor 1200 of FIG. 12 executing machine executable instructions such as those implemented by at least block 830 of FIG. 8. In some examples, the prediction layer assignment circuitry 315 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the prediction layer assignment circuitry 315 may be instantiated by any other combination of hardware, software, and/or firmware. For example, the prediction layer assignment circuitry 315 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the encoder enhancement circuitry 205 includes means for computing SIF scores. For example, the means for computing SIF scores may be implemented by the SIF score computation circuitry 320. In some examples, the SIF score computation circuitry 320 may be instantiated by programmable circuitry such as the example programmable circuitry 1112 of FIG. 11. For instance, the SIF score computation circuitry 320 may be instantiated by the example microprocessor 1200 of FIG. 12 executing machine executable instructions such as those implemented by at least block 835 of FIG. 8. In some examples, the SIF score computation circuitry 320 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the SIF score computation circuitry 320 may be instantiated by any other combination of hardware, software, and/or firmware. For example, the SIF score computation circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the encoder enhancement circuitry 205 includes means for generating AI suitability metrics for video frames. For example, the means for generating AI suitability metrics may be implemented by the AI metric generation circuitry 325. In some examples, the AI metric generation circuitry 325 may be instantiated by programmable circuitry such as the example programmable circuitry 1112 of FIG. 11. For instance, the AI metric generation circuitry 325 may be instantiated by the example microprocessor 1200 of FIG. 12 executing machine executable instructions such as those implemented by at least block 920 of FIG. 9. In some examples, the AI metric generation circuitry 325 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the AI metric generation circuitry 325 may be instantiated by any other combination of hardware, software, and/or firmware. For example, the AI metric generation circuitry 325 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the encoder enhancement circuitry 205 includes means for interfacing. For example, the means for interfacing may be implemented by the interface circuitry 330. In some examples, the interface circuitry 330 may be instantiated by programmable circuitry such as the example programmable circuitry 1112 of FIG. 11. For instance, the interface circuitry 330 may be instantiated by the example microprocessor 1200 of FIG. 12 executing machine executable instructions such as those implemented by at least blocks 805-815 and 840 of FIG. 8. In some examples, the interface circuitry 330 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the interface circuitry 330 may be instantiated by any other combination of hardware, software, and/or firmware. For example, the interface circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 7 is a block diagram illustrating the example decoder enhancement circuitry 210 and the example video decoder circuitry 212 included in the example video codec of FIG. 2. The decoder enhancement circuitry 210 and/or the video decoder circuitry 212 of FIG. 7 may be instantiated (e.g., creating an instance of, bring into being for any length of time, materialize, implement, etc.) by programmable circuitry such as a Central Processor Unit (CPU) executing first instructions. Additionally or alternatively, the decoder enhancement circuitry 210 and/or the video decoder circuitry 212 of FIG. 7 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

In the illustrated example of FIG. 7, the decoder enhancement circuitry 210 includes example layer assignment decode circuitry 705, example SIF score decode circuitry 710, example, frame skip decision circuitry 715 and example interface circuitry 720. The interface circuitry 720 of the decoder enhancement circuitry 210 accesses an example encoded video bitstream 725, which may be similar to the example encoded video bitstream 250. As such, the encoded video bitstream 725 includes prediction layer metadata, such as the prediction layer metadata 235, and SIF metadata, such as the SIF metadata 240, for video frames encoded in the encoded video bitstream 725.

The layer assignment decode circuitry 705 of the illustrated example decodes or otherwise accesses the prediction layer metadata for a given video frame encoded in the encoded video bitstream 725. In the illustrated example, the prediction layer metadata identifies a particular prediction layer of the dynamic encoding prediction structure 610 to which the given video frame to be decoded has been assigned, as described above. In some examples, the prediction layer metadata also specifies the preceding frame(s) of the video bitstream on which the given video frame depends for decoding, as also described above.

The SIF score decode circuitry 710 of the illustrated example decodes or otherwise accesses the SIF metadata for a given video frame encoded in the encoded video bitstream 725. In the illustrated example, the SIF score 240 determined by the SIF score computation circuitry 320 represents a probability, likelihood, etc., that the given video frame 215 to be decoded will be useful (or, in other words, suitable for inference) in the context of the AI processing performed at the compute node associated with the decoder enhancement circuitry 210 and the example video decoder circuitry 212. For example, SIF scores may cover a possible range of values, such as 0 to 1, 0 to 100, etc., or may cover a set of categories, such as (“low,” “medium,” “high”), (“poor,” “average,” “good”), etc.

The frame skip decision circuitry 715 of the illustrated example determines whether to skip decoding of a given video frame in the encoded video bitstream 725 based on the prediction layer metadata and/or the SIF metadata decoded from the encoded video bitstream 725 for that video frame. For example, the frame skip decision circuitry 715 determines whether to skip decoding of a given video frame in the encoded video bitstream 725 based on the prediction layer metadata decoded from the encoded video bitstream 725 for that video frame. In some examples, the frame skip decision circuitry 715 determines that the given video frame is to be decoded if the given video frame is assigned to the base (e.g., lowest) layer 615 of the dynamic encoding prediction structure 610, and determines that decoding of the given video frame is to be skipped if the prediction layer metadata specifies that the given video frame is assigned to one of the higher layers 620 or 625 of the dynamic encoding prediction structure 610. However, in some examples, the frame skip decision circuitry 715 determines that the given video frame is to be decoded if the given video frame is assigned to the base (e.g., lowest) layer 615 or the intermediate layer 620 of the dynamic encoding prediction structure 610, and determines that decoding of the given video frame is to be skipped if the prediction layer metadata specifies that the given video frame is assigned to the highest layers 625 of the dynamic encoding prediction structure 610.

In some examples, the frame skip decision circuitry 715 determines whether to skip decoding of a given video frame in the encoded video bitstream 725 based on the SIF metadata decoded from the encoded video bitstream 725 for that video frame. For example, the frame skip decision circuitry 715 may determine that the given video frame is to be decoded if the given video frame has a SIF score that satisfies (e.g., meets or exceeds) a threshold or corresponds to a permitted decoding category (e.g., such as SIF score of “high” or “good”, or a SIF score of “medium,” “high,” “average,” or “good”). Conversely, the frame skip decision circuitry 715 may determine that decoding of the given video frame is to be skipped if the SIF score for that the given video frame does not satisfy the threshold or does not correspond to a permitted decoding category (e.g., such as a SIF score of “low” or “poor”).

In some examples, the frame skip decision circuitry 715 determines whether to skip decoding of a given video frame in the encoded video bitstream 725 based on a combination of the prediction layer metadata and the SIF metadata decoded from the encoded video bitstream 725 for that video frame. For example, the frame skip decision circuitry 715 may determine that the given video frame is to be decoded if the given video frame is assigned to the base (e.g., lowest) layer 615 of the dynamic encoding prediction structure 610, or is assigned to the intermediate layer 620 of the dynamic encoding prediction structure 610 and has a SIF score that satisfies a threshold. Conversely, the frame skip decision circuitry 715 may determine that decoding of the given video frame is to be skipped if the given video frame is assigned to the highest layer 625 of the dynamic encoding prediction structure 610, or is assigned to the intermediate layer 620 of the dynamic encoding prediction structure 610 and has a SIF score that does not satisfy the threshold.

In the illustrated example, the frame skip decision circuitry 715 outputs example instructions 730 to the video decoder circuitry 212 via the interface circuitry 730. The instructions 730 instruct the video decoder circuitry 212 to decode or skip decoding of respective video frames included in the encoded video bitstream 725. The video decoder circuitry 212 of the illustrated example accesses the encoded video bitstream 725 and decodes or skips decoding of the respective video frames of the encoded video bitstream 725 in accordance with the instructions 730. In some examples, the video decoder circuitry 212 also decodes the selected video frames based on the preceding (reference) frames specified in the prediction layer metadata for the respective video frames. In the illustrated example, the video decoder circuitry 212 outputs example decoded video frames 735 corresponding to the encoded frames the frame skip decision circuitry 715 instructed the video decoder circuitry 212 to decode.

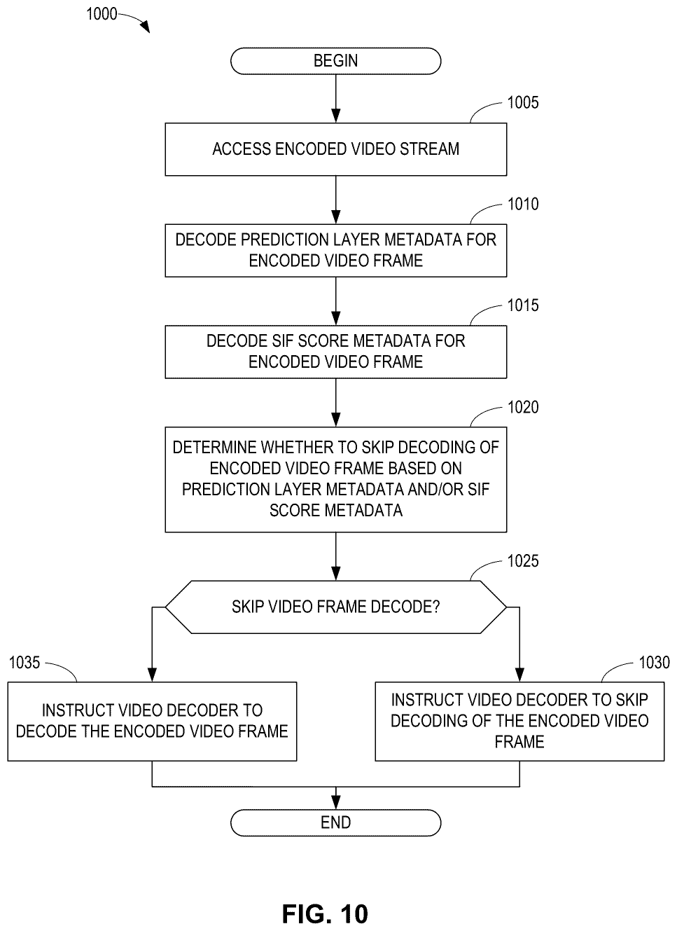

In some examples, the decoder enhancement circuitry 210 includes means for decoding layer assignment metadata for video frames. For example, the means for decoding layer assignment metadata may be implemented by the layer assignment decode circuitry 705. In some examples, the layer assignment decode circuitry 705 may be instantiated by programmable circuitry such as the example programmable circuitry 1112 of FIG. 11. For instance, the layer assignment decode circuitry 705 may be instantiated by the example microprocessor 1200 of FIG. 12 executing machine executable instructions such as those implemented by at least block 1010 of FIG. 10. In some examples, the layer assignment decode circuitry 705 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the layer assignment decode circuitry 705 may be instantiated by any other combination of hardware, software, and/or firmware. For example, the layer assignment decode circuitry 705 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the decoder enhancement circuitry 210 includes means for decoding SIF metadata for video frames. For example, the means for decoding SIF score metadata may be implemented by the SIF score decode circuitry 710. In some examples, the SIF score decode circuitry 710 may be instantiated by programmable circuitry such as the example programmable circuitry 1112 of FIG. 11. For instance, the SIF score decode circuitry 710 may be instantiated by the example microprocessor 1200 of FIG. 12 executing machine executable instructions such as those implemented by at least block 1015 of FIG. 10. In some examples, the SIF score decode circuitry 710 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the SIF score decode circuitry 710 may be instantiated by any other combination of hardware, software, and/or firmware. For example, the SIF score decode circuitry 710 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the decoder enhancement circuitry 210 includes means for determining whether to skip decoding of video frames. For example, the means for determining whether to skip decoding may be implemented by the frame skip decision circuitry 715. In some examples, the frame skip decision circuitry 715 may be instantiated by programmable circuitry such as the example programmable circuitry 1112 of FIG. 11. For instance, the frame skip decision circuitry 715 may be instantiated by the example microprocessor 1200 of FIG. 12 executing machine executable instructions such as those implemented by at least blocks 1020-1035 of FIG. 10. In some examples, the frame skip decision circuitry 715 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the frame skip decision circuitry 715 may be instantiated by any other combination of hardware, software, and/or firmware. For example, the frame skip decision circuitry 715 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the decoder enhancement circuitry 210 includes means for interfacing. For example, the means for interfacing may be implemented by the interface circuitry 720. In some examples, the interface circuitry 720 may be instantiated by programmable circuitry such as the example programmable circuitry 1112 of FIG. 11. For instance, the interface circuitry 720 may be instantiated by the example microprocessor 1200 of FIG. 12 executing machine executable instructions such as those implemented by at least blocks 1005, 1030 and 1035 of FIG. 8. In some examples, the interface circuitry 720 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the interface circuitry 720 may be instantiated by any other combination of hardware, software, and/or firmware. For example, the interface circuitry 720 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the video codec 200 is illustrated in FIGS. 1-7, one or more of the elements, processes, and/or devices illustrated in FIGS. 1-7 may be combined, divided, re-arranged, omitted, eliminated, and/or implemented in any other way. Further, the example encoder enhancement circuitry 205, the example video encoder circuitry 208, the example decoder enhancement circuitry 210, the example video decoder circuitry 212, the example AI metric evaluation circuitry 305, the example video metric evaluation circuitry 310, the example prediction layer assignment circuitry 315, the example SIF score computation circuitry 320, the example AI metric generation circuitry 325, the example interface circuitry 330, the example layer assignment decode circuitry 705, example SIF score decode circuitry 710, example, frame skip decision circuitry 715 and example interface circuitry 720 and/or, more generally, the example video codec 200 may be implemented by hardware alone or by hardware in combination with software and/or firmware. Thus, for example, any of the example encoder enhancement circuitry 205, the example video encoder circuitry 208, the example decoder enhancement circuitry 210, the example video decoder circuitry 212, the example AI metric evaluation circuitry 305, the example video metric evaluation circuitry 310, the example prediction layer assignment circuitry 315, the example SIF score computation circuitry 320, the example AI metric generation circuitry 325, the example interface circuitry 330, the example layer assignment decode circuitry 705, example SIF score decode circuitry 710, example, frame skip decision circuitry 715 and example interface circuitry 720 and/or, more generally, the example video codec 200 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example video codec 200 may include one or more elements, processes, and/or devices in addition to, or instead of, those illustrated in FIGS. 1-7, and/or may include more than one of any or all of the illustrated elements, processes and devices.

Flowchart(s) representative of example machine readable instructions, which may be executed by programmable circuitry to implement and/or instantiate the video codec 200 and/or representative of example operations which may be performed by programmable circuitry to implement and/or instantiate the video codec 200, are shown in FIGS. 8-10. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 8-10, many other methods of implementing the example video codec 200 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8-10 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 8 is a flowchart representative of example machine readable instructions and/or example operations 800 that may be executed, instantiated, and/or performed by programmable circuitry to implement the example encoder enhancement circuitry 205 of the video codec 200. The example machine-readable instructions and/or the example operations 800 of FIG. 8 begin at block 805, at which the interface circuitry 330 of the encoder enhancement circuitry 205 accesses a next input video frame to be encoded. At block 810, the video metric evaluation circuitry 310 of the encoder enhancement circuitry 205 obtains input video metric(s) associated with the input video frame, as described above. At block 815, the AI metric evaluation circuitry 305 of the encoder enhancement circuitry 205 obtains input AI metric(s) associated with the input video frame, as described above.

At block 820, the video metric evaluation circuitry 310 evaluates or otherwise processes the input video metric(s), as described above, to determine filtered video metric(s) associated with the input video frame accessed at block 805. Additionally or alternatively, at block 820, the video metric evaluation circuitry 310 evaluates or otherwise processes the input video frame accessed at block 805 and/or one or more preceding video frames, as described above, to determine the filtered video metric(s) associated with the input video frame accessed at block 805.

At block 825, the AI metric evaluation circuitry 305 evaluates or otherwise processes the input AI metric(s), as described above, to determine filtered AI metric(s) associated with the input video frame accessed at block 805. Additionally or alternatively, at block 825, the video metric evaluation circuitry 310 evaluates or otherwise processes the input video frame accessed at block 805 and/or one or more preceding video frames, as described above, to determine the filtered AI metric(s) associated with the input video frame accessed at block 805. Example machine readable instructions and/or example operations that may be executed, instantiated, and/or performed by programmable circuitry to implement the processing at block 825 are illustrated in FIG. 9, which is described below.

At block 830, the prediction layer assignment circuitry 315 of the encoder enhancement circuitry 205 assigns the input video frame accessed at block 805 to a prediction layer of the dynamic encoding prediction structure 610 based on the filtered video metric(s) and/or the filtered AI metric(s) associated with the input video frame, as described above. At block 830, the prediction layer assignment circuitry 315 also outputs prediction layer metadata specifying the prediction layer to which the input video frame was assigned, as described above. At block 835, the SIF score computation circuitry 320 of the encoder enhancement circuitry 205 determines a SIF score for the input video frame accessed at block 805 based on the filtered video metric(s) and/or the filtered AI metric(s) associated with the input video frame, as described above. At block 835, the SIF score computation circuitry 320 also outputs SIF score metadata including the SIF score computed for the input video frame, as described above. At block 845, the interface circuitry 330 of the encoder enhancement circuitry 205 outputs prediction layer metadata and the SIF score metadata to the video encoder circuitry 208, which is to encode the input video frame based on the prediction layer metadata, and also encode the prediction layer metadata and the SIF score metadata in the encoded video bitstream, as described above. The example machine readable instructions and/or example operations 800 then end.

FIG. 9 is a flowchart representative of example machine readable instructions and/or example operations 825 that may be executed, instantiated, and/or performed by programmable circuitry to implement the processing at block 825 of FIG. 8. The example machine-readable instructions and/or the example operations 825 of FIG. 9 begin at block 905, at which the AI metric evaluation circuitry 305 of the encoder enhancement circuitry 205 determines whether input AI metric(s) associated with the current input video frame are available from the video encoder circuitry 208. If input AI metric(s) are available, at block 910 the AI metric evaluation circuitry 305 includes the input AI metric(s) in the set of filtered AI metric(s) associated with the current input video frame.

At block 915, the AI metric evaluation circuitry 305 determines whether downstream AI suitability model(s) are available, such as those implemented by the AI metric generation circuitry 325 described above. If downstream AI suitability model(s) are available, at block 920 the AI metric generation circuitry 325 of the encoder enhancement circuitry 205 processes the input video frame with the downstream AI suitability model(s) to determine AI suitability metric(s) for the input video frame, as described above. At block 925, the AI metric evaluation circuitry 305 includes the AI suitability metric(s) in the set of filtered AI metric(s) associated with the current input video frame. At block 930, the AI metric evaluation circuitry 305 outputs the set of filtered AI metric(s) associated with the current input video frame. The example machine readable instructions and/or example operations 825 then end.

FIG. 10 is a flowchart representative of example machine readable instructions and/or example operations 1000 that may be executed, instantiated, and/or performed by programmable circuitry to implement the example decoder enhancement circuitry 210 of the video codec 200. The example machine-readable instructions and/or the example operations 1000 of FIG. 8 begin at block 1005, at which the interface circuitry 720 of the decoder enhancement circuitry 210 access an encoded video stream that is to be decoded by the video decoder circuitry 212. At block 1010, the layer assignment decode circuitry 705 of the decoder enhancement circuitry 210 decodes prediction layer metadata for a given encoded video frame from the encoded video stream accessed at block 1005, as described above. At block 1015, the SIF score decode circuitry 710 of the decoder enhancement circuitry 210 decodes SIF score metadata for the given encoded video frame from the encoded video stream accessed at block 1005, as described above. At block 1020, the frame skip decision circuitry 715 of the decoder enhancement circuitry 210 determines, based on the prediction layer metadata obtained at block 1010 and/or the SIF score metadata obtained at block 1015, whether to skip decoding of the encoded video frame, as described above. If decoding of the encoded video frame is to be skipped (block 1025), then at block 1030 the frame skip decision circuitry 715 outputs an instruction, via the interface circuitry 720, to the video decoder circuitry 212 to skip decoding of the encoded video frame, as described above. However, if decoding of the encoded video frame is not to be skipped (block 1025), then at block 1035 the frame skip decision circuitry 715 outputs an instruction, via the interface circuitry 720, to the video decoder circuitry 212 to decode the encoded video frame, as described above. The example machine readable instructions and/or example operations 1000 then end.

FIG. 11 is a block diagram of an example programmable circuitry platform 1100 structured to execute and/or instantiate the example machine-readable instructions and/or the example operations of FIGS. 8-10 to implement the video codec 200. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the video codec 200 and/or, more specifically, one or more of the example encoder enhancement circuitry 205, the example video encoder circuitry 208, the example decoder enhancement circuitry 210, the example video decoder circuitry 212, the example AI metric evaluation circuitry 305, the example video metric evaluation circuitry 310, the example prediction layer assignment circuitry 315, the example SIF score computation circuitry 320, the example AI metric generation circuitry 325, the example interface circuitry 330, the example layer assignment decode circuitry 705, example SIF score decode circuitry 710, example, frame skip decision circuitry 715 and/or example interface circuitry 720.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 1120 implements the example interface circuitry 330 and/or the example interface circuitry 720.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 8-10, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 8-10 to effectively instantiate the circuitry of FIG. 2 as logic circuits to perform operations corresponding to those machine readable instructions. In some such examples, the circuitry of FIG. 2 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 8-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 8-10 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 8-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 8-10. As such, the FPGA circuitry 1300 may be configured and/or structured to effectively instantiate some or all of the operations/functions corresponding to the machine readable instructions of the flowchart(s) of FIGS. 8-10 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 8-10 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 8-10 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 8-10 to perform first operation(s)/function(s), the FPGA circuitry 1300 of FIG. 13 may be configured and/or structured to perform second operation(s)/function(s) corresponding to a second portion of the machine readable instructions represented by the flowcharts of FIG. 8-10, and/or an ASIC may be configured and/or structured to perform third operation(s)/function(s) corresponding to a third portion of the machine readable instructions represented by the flowcharts of FIGS. 8-10.

It should be understood that some or all of the circuitry of FIG. 2 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 2 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

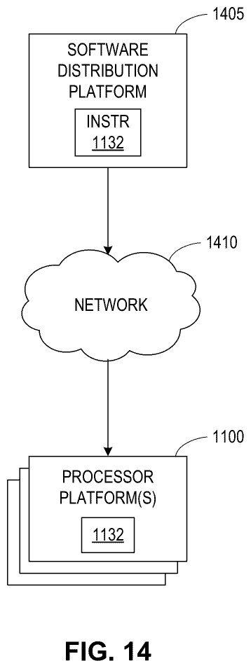

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 8-10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIG. 8-10, may be downloaded to the example programmable circuitry platform 1100, which is to execute the machine readable instructions 1132 to implement the video codec 200. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement enhanced video encoders and enhanced video decoders for artificial intelligence applications. Example enhanced video encoders and decoders disclosed herein focus video decoding on video frames that are likely to be useful for AI processing in a compute node, and skip decoding of video frames that are unlikely to be useful for AI processing. By skipping the decoding of video frames that are unlikely to be useful for AI processing, such example enhanced video encoders and decoders can conserve computational and/or memory resources of the compute node, thereby allowing more resources to be available for AI processing. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising interface circuitry, machine readable instructions, and at least one processor circuit to be programmed by the machine readable instructions to assign a video frame to one of a plurality of layers of an encoding prediction structure based on at least one of a video metric or an artificial intelligence metric associated with the video frame, and provide prediction layer metadata for the video frame to a video encoder that is to encode the video frame in a video stream, the prediction layer metadata to identify the one of the plurality of layers.

Example 2 includes the apparatus of example 1, wherein one or more of the at least one processor circuit is to determine a score associated with the video frame, the score based on the at least one of the video metric or the artificial intelligence metric associated with the video frame, and provide the score to the video encoder.

Example 3 includes the apparatus of example 2, wherein the score is an inference score, the artificial intelligence metric is output from an artificial intelligence application based on the video frame, the artificial intelligence metric is to specify an object detected in the video frame and a corresponding classification score for the object, and one or more of the at least one processor circuit is to determine the inference score based on the object and the corresponding classification score.

Example 4 includes the apparatus of example 3, wherein the video frame is a first video frame, the object and the corresponding classification score are in a first set of objects and a corresponding first set of classification scores, and one or more of the at least one processor circuit is to compare the first set of objects to a second set of objects detected in a preceding second video frame to determine a number of new objects detected in the first video frame, set the inference score to a first value in response to the number of new objects being greater than one and at least one new object having a corresponding classification score that satisfies a threshold, and set the inference score to a second value less than the first value in response to the number of new objects being greater than one and no new object having a corresponding classification score that satisfies a threshold, and set the inference score to a third value less than both the first value and the second value in response to the number of new objects being zero.

Example 5 includes the apparatus of example 3, wherein the video frame is a first video frame, the video metric corresponds to motion vector information associated with a preceding second video frame, and one or more of the at least one processor circuit is to determine the inference score based on the object, the corresponding classification score and the motion vector information.

Example 6 includes the apparatus of example 1, wherein the artificial intelligence metrics is one of a plurality of artificial intelligence metrics output from an artificial intelligence application based on the video frame, the plurality of artificial intelligence metrics to specify a set of objects detected in the video frame and a corresponding set of classification scores for the set of objects, and one or more of the at least one processor circuit is to assign the video frame to the one of the plurality of layers of the encoding prediction structure based on the set of objects and the corresponding set of classification scores.

Example 7 includes the apparatus of example 6, wherein the plurality of layers of the encoding prediction structure includes a first layer, a second layer higher than the first layer, and one or more of the at least one processor circuit is to assign the video frame to the first layer in response to the set of objects including at least one object and the corresponding set of classification scores including at least one classification score that satisfies a threshold, and assign the video frame to the second layer in response to the set of objects including at least one object and the corresponding set of classification scores including no classification score that satisfies a threshold.

Example 8 includes the apparatus of example 7, wherein the video frame is a first video frame, the threshold is a first threshold, the plurality of layers of the encoding prediction structure includes a third layer higher than both the first layer and the second layer, the video metric corresponds to a frame difference metric, and one or more of the at least one processor circuit is to compute a sum of absolute differences between pixels of the first video frame and corresponding pixels of a preceding second video frame to determine the frame difference metric, and assign the video frame to the third layer in response to at least one of (i) the set of objects including no objects, or (ii) the frame difference metric not satisfying a second threshold.

Example 9 includes the apparatus of example 1, wherein one or more of the at least one processor circuit is to assign the video frame to the one of the plurality of layers of the encoding prediction structure based on the video metric and the artificial intelligence metric associated with the video frame.

Example 10 includes the apparatus of example 1, wherein the prediction layer metadata is to identify one or more reference frames used to encode the video frame.

Example 11 includes an apparatus comprising interface circuitry, machine readable instructions, and at least one processor circuit to be programmed by the machine readable instructions to access at least one of prediction layer metadata or score metadata encoded in an encoded video stream, the at least one of the prediction layer metadata or the score metadata associated with an encoded video frame, the prediction layer metadata to specify one of a plurality of layers of an encoding prediction structure to which the encoded video frame is assigned, and instruct a video decoder to skip decoding of the encoded video frame based on at least one of the prediction layer metadata or the score metadata.

Example 12 includes the apparatus of example 11, wherein the plurality of layers of the encoding prediction structure includes a first layer and a second layer higher than the first layer, and one or more of the at least one processor circuit is to instruct the video decoder to skip decoding of the encoded video frame based on the prediction layer metadata specifying the encoded video frame is assigned to the second layer, and instruct the video decoder to decode the encoded video frame based on the prediction layer metadata specifying the encoded video frame is assigned to the first layer.

Example 13 includes the apparatus of example 11, wherein the plurality of layers of the encoding prediction structure includes a first layer, a second layer higher than the first layer, and a third layer higher than both the first layer and the second layer, and one or more of the at least one processor circuit is to instruct the video decoder to skip decoding of the encoded video frame based on the prediction layer metadata specifying the encoded video frame is assigned to the third layer, and instruct the video decoder to decode the encoded video frame based on the prediction layer metadata specifying the encoded video frame is assigned to the first layer or the second layer.

Example 14 includes the apparatus of example 11, wherein the plurality of layers of the encoding prediction structure includes a first layer, a second layer higher than the first layer, and a third layer higher than both the first layer and the second layer, and one or more of the at least one processor circuit is to instruct the video decoder to skip decoding of the encoded video frame based on the prediction layer metadata specifying the encoded video frame is assigned to the second layer or the third layer, and instruct the video decoder to decode the encoded video frame based on the prediction layer metadata specifying the encoded video frame is assigned to the first layer.

Example 15 includes the apparatus of example 11, wherein one or more of the at least one processor circuit is to instruct the video decoder to skip decoding of the encoded video frame based on the score metadata not satisfying a threshold, and instruct the video decoder to decode the encoded video frame based on the score metadata satisfying the threshold.

Example 16 includes the apparatus of example 11, wherein the prediction layer metadata is to specify one or more reference frames used to encode the encoded video frame, and one or more of the at least one processor circuit is to provide the prediction layer metadata to the video decoder.

Example 17 includes at least one non-transitory computer readable storage medium comprising instructions to cause at least one processor circuit to at least access at least one of prediction layer metadata or score metadata from an encoded video stream, the at least one of the prediction layer metadata or the score metadata associated with an encoded video frame of the encoded video stream, the prediction layer metadata to specify one of a plurality of layers of an encoding prediction structure to which the encoded video frame is assigned, and cause a video decoder to skip decoding of the encoded video frame based on at least one of the prediction layer metadata or the score metadata.

Example 18 includes the least one non-transitory computer readable storage medium of example 17, wherein the plurality of layers of the encoding prediction structure includes a first layer and a second layer higher than the first layer, and the instructions are to cause one or more of the at least one processor circuit to instruct the video decoder to skip decoding of the encoded video frame based on the prediction layer metadata specifying the encoded video frame is assigned to the second layer, and instruct the video decoder to decode the encoded video frame based on the prediction layer metadata specifying the encoded video frame is assigned to the first layer.

Example 19 includes the least one non-transitory computer readable storage medium of example 17, wherein the instructions are to cause one or more of the at least one processor circuit to instruct the video decoder to skip decoding of the encoded video frame based on the score metadata not satisfying a threshold, and instruct the video decoder to decode the encoded video frame based on the score metadata satisfying the threshold.

Example 20 includes the least one non-transitory computer readable storage medium of example 17, wherein the prediction layer metadata is to specify one or more reference frames used to encode the encoded video frame, and the instructions are to cause one or more of the at least one processor circuit to provide the prediction layer metadata to the video decoder.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
at least one processor circuit to be programmed by the machine readable instructions to:
assign a video frame to one of a plurality of layers of an encoding prediction structure based on at least one of a video metric or an artificial intelligence metric associated with the video frame; and
provide prediction layer metadata for the video frame to a video encoder that is to encode the video frame in a video stream, the prediction layer metadata to identify the one of the plurality of layers.

2. The apparatus of claim 1, wherein one or more of the at least one processor circuit is to:
determine a score associated with the video frame, the score based on the at least one of the video metric or the artificial intelligence metric associated with the video frame; and
provide the score to the video encoder.

3. The apparatus of claim 2, wherein the score is an inference score, the artificial intelligence metric is output from an artificial intelligence application based on the video frame, the artificial intelligence metric is to specify an object detected in the video frame and a corresponding classification score for the object, and one or more of the at least one processor circuit is to determine the inference score based on the object and the corresponding classification score.

4. The apparatus of claim 3, wherein the video frame is a first video frame, the object and the corresponding classification score are in a first set of objects and a corresponding first set of classification scores, and one or more of the at least one processor circuit is to:
compare the first set of objects to a second set of objects detected in a preceding second video frame to determine a number of new objects detected in the first video frame;
set the inference score to a first value in response to the number of new objects being greater than one and at least one new object having a corresponding classification score that satisfies a threshold; and
set the inference score to a second value less than the first value in response to the number of new objects being greater than one and no new object having a corresponding classification score that satisfies a threshold; and
set the inference score to a third value less than both the first value and the second value in response to the number of new objects being zero.

5. The apparatus of claim 3, wherein the video frame is a first video frame, the video metric corresponds to motion vector information associated with a preceding second video frame, and one or more of the at least one processor circuit is to determine the inference score based on the object, the corresponding classification score and the motion vector information.

6. The apparatus of claim 1, wherein the artificial intelligence metrics is one of a plurality of artificial intelligence metrics output from an artificial intelligence application based on the video frame, the plurality of artificial intelligence metrics to specify a set of objects detected in the video frame and a corresponding set of classification scores for the set of objects, and one or more of the at least one processor circuit is to assign the video frame to the one of the plurality of layers of the encoding prediction structure based on the set of objects and the corresponding set of classification scores.

7. The apparatus of claim 6, wherein the plurality of layers of the encoding prediction structure includes a first layer, a second layer higher than the first layer, and one or more of the at least one processor circuit is to:
assign the video frame to the first layer in response to the set of objects including at least one object and the corresponding set of classification scores including at least one classification score that satisfies a threshold; and
assign the video frame to the second layer in response to the set of objects including at least one object and the corresponding set of classification scores including no classification score that satisfies a threshold.

8. The apparatus of claim 7, wherein the video frame is a first video frame, the threshold is a first threshold, the plurality of layers of the encoding prediction structure includes a third layer higher than both the first layer and the second layer, the video metric corresponds to a frame difference metric, and one or more of the at least one processor circuit is to:
compute a sum of absolute differences between pixels of the first video frame and corresponding pixels of a preceding second video frame to determine the frame difference metric; and
assign the video frame to the third layer in response to at least one of (i) the set of objects including no objects, or (ii) the frame difference metric not satisfying a second threshold.

9. The apparatus of claim 1, wherein one or more of the at least one processor circuit is to assign the video frame to the one of the plurality of layers of the encoding prediction structure based on the video metric and the artificial intelligence metric associated with the video frame.

10. The apparatus of claim 1, wherein the prediction layer metadata is to identify one or more reference frames used to encode the video frame.

11. An apparatus comprising:
interface circuitry;
machine readable instructions; and
at least one processor circuit to be programmed by the machine readable instructions to:
access at least one of prediction layer metadata or score metadata encoded in an encoded video stream, the at least one of the prediction layer metadata or the score metadata associated with an encoded video frame, the prediction layer metadata to specify one of a plurality of layers of an encoding prediction structure to which the encoded video frame is assigned; and
instruct a video decoder to skip decoding of the encoded video frame based on at least one of the prediction layer metadata or the score metadata.

12. The apparatus of claim 11, wherein the plurality of layers of the encoding prediction structure includes a first layer and a second layer higher than the first layer, and one or more of the at least one processor circuit is to:
instruct the video decoder to skip decoding of the encoded video frame based on the prediction layer metadata specifying the encoded video frame is assigned to the second layer; and
instruct the video decoder to decode the encoded video frame based on the prediction layer metadata specifying the encoded video frame is assigned to the first layer.

13. The apparatus of claim 11, wherein the plurality of layers of the encoding prediction structure includes a first layer, a second layer higher than the first layer, and a third layer higher than both the first layer and the second layer, and one or more of the at least one processor circuit is to:
instruct the video decoder to skip decoding of the encoded video frame based on the prediction layer metadata specifying the encoded video frame is assigned to the third layer; and
instruct the video decoder to decode the encoded video frame based on the prediction layer metadata specifying the encoded video frame is assigned to the first layer or the second layer.

14. The apparatus of claim 11, wherein the plurality of layers of the encoding prediction structure includes a first layer, a second layer higher than the first layer, and a third layer higher than both the first layer and the second layer, and one or more of the at least one processor circuit is to:
instruct the video decoder to skip decoding of the encoded video frame based on the prediction layer metadata specifying the encoded video frame is assigned to the second layer or the third layer; and
instruct the video decoder to decode the encoded video frame based on the prediction layer metadata specifying the encoded video frame is assigned to the first layer.

15. The apparatus of claim 11, wherein one or more of the at least one processor circuit is to:
instruct the video decoder to skip decoding of the encoded video frame based on the score metadata not satisfying a threshold; and
instruct the video decoder to decode the encoded video frame based on the score metadata satisfying the threshold.

16. The apparatus of claim 11, wherein the prediction layer metadata is to specify one or more reference frames used to encode the encoded video frame, and one or more of the at least one processor circuit is to provide the prediction layer metadata to the video decoder.

17. At least one non-transitory computer readable storage medium comprising instructions to cause at least one processor circuit to at least:
access at least one of prediction layer metadata or score metadata from an encoded video stream, the at least one of the prediction layer metadata or the score metadata associated with an encoded video frame of the encoded video stream, the prediction layer metadata to specify one of a plurality of layers of an encoding prediction structure to which the encoded video frame is assigned; and
cause a video decoder to skip decoding of the encoded video frame based on at least one of the prediction layer metadata or the score metadata.

18. The least one non-transitory computer readable storage medium of claim 17, wherein the plurality of layers of the encoding prediction structure includes a first layer and a second layer higher than the first layer, and the instructions are to cause one or more of the at least one processor circuit to:
instruct the video decoder to skip decoding of the encoded video frame based on the prediction layer metadata specifying the encoded video frame is assigned to the second layer; and
instruct the video decoder to decode the encoded video frame based on the prediction layer metadata specifying the encoded video frame is assigned to the first layer.

19. The least one non-transitory computer readable storage medium of claim 17, wherein the instructions are to cause one or more of the at least one processor circuit to:
instruct the video decoder to skip decoding of the encoded video frame based on the score metadata not satisfying a threshold; and
instruct the video decoder to decode the encoded video frame based on the score metadata satisfying the threshold.

20. The least one non-transitory computer readable storage medium of claim 17, wherein the prediction layer metadata is to specify one or more reference frames used to encode the encoded video frame, and the instructions are to cause one or more of the at least one processor circuit to provide the prediction layer metadata to the video decoder.
